(19) United States
(12) Patent Application Publication
(10) Pub. No.: US 2025/0305167 A1
(43) Pub. Date: Oct. 2, 2025

(54) ELECTRODE COMPOSITIONS

(71) Applicant: Commonwealth Scientific and Industrial Research Organisation, Acton (AU)

(72) Inventors: Aniruddha Kulkarni, Clayton (AU); Sarb Giddey, Clayton (AU); Gurpreet Kaur, Clayton (AU); Saheli Biswas, Clayton (AU)

(21) Appl. No.: 18/854,505

(22) PCT Filed: Apr. 6, 2023
(86) PCT No.: PCT/AU2023/050283

§ 371 Date: Oct. 4, 2024

(30) Foreign Application Priority Data
Apr. 6, 2022 (AU) 2022900905

(51) Int. Cl. C25B 11/093; C25B 1/04; C25B 1/23; C25B 11/031; C25B 11/037; H01M 4/86; H01M 4/88; H01M 4/90; H01M 8/12

(52) U.S. Cl. CPC C25B 11/093; C25B 1/04; C25B 1/23; C25B 11/031; C25B 11/037; H01M 4/8605; H01M 4/8885; H01M 4/9066; H01M 8/12; H01M 2008/1293

(57) ABSTRACT

The present disclosure relates to electrode compositions, in particular electrode compositions comprising hybrid electrode particles, which can be used in solid oxide electrochemical cells. The present disclosure also relates to processes for preparing hybrid electrode particles. The present disclosure also relates to electrodes, including sintered electrodes, comprising the electrode compositions, and to solid oxide electrochemical cells comprising the electrode compositions.

### FIELD

The present disclosure relates to electrode compositions, in particular electrode compositions comprising hybrid electrode particles, which can be used in solid oxide electrochemical cells. The present disclosure also relates to processes for preparing hybrid electrode particles. The present disclosure also relates to electrodes, including sintered electrodes, comprising the electrode compositions, and to solid oxide electrochemical cells comprising the electrode compositions.

### BACKGROUND

Electrochemical cells, including solid oxide electrolysis cells (SOECs) and solid oxide fuel cells (SOFCs) provide numerous advantages over existing energy system technologies such as natural gas reforming for hydrogen generation and coal fired plants for electricity. For example, solid oxide electrolysis cells (SOECs) have a tremendous potential to provide a practical pathway for on demand production of high purity hydrogen, CO or syngas by using water and recycled waste CO₂ from industrial processes. In particular, hydrogen, CO and/or syngas are an important feedstock for production of numerous chemicals required for the pharmaceutical, food and plastics industry. In addition, hydrogen can be used in the energy sector directly or for further production of various value-added fuels such as green ammonia, methanol, dimethyl ether, etc., as stated above.

Despite promising pre-commercial demonstrations, some key technical challenges need to be addressed to make this technology economically feasible. These include lowering capital costs with low cost materials and cell designs, and improvements in the electrode performance and lifetime, including identifying new and improved electrode materials which are the key drivers for electrochemical performance. Other problems that currently exist with current electrodes (e.g. conventional nickel-YSZ cathodes) include susceptibility to degradation in either fuel or oxidizing environments, high cell fabrication and operating temperatures. Additionally, external reducing gases are required in the feed stream to maintain current electrodes in the reduced state thus increases cost and complexity

As such, there is a need for alternative or improved electrode compositions for use in solid oxide electrochemical cells, and methods for preparing electrode compositions for solid oxide electrochemical cells, which are scalable for industrial applications.

It will be understood that any prior art publications referred to herein do not constitute an admission that any of these documents form part of the common general knowledge in the art, in Australia or in any other country.

### SUMMARY

The present disclosure provides particular electrode compositions that are scalable for industrial application, and provide control, flexibility and consistency in the manufacture of electrodes, including electrodes for use in solid oxide electrochemical cells (e.g. solid oxide electrolysis cells (SOECs) and solid oxide fuel cells (SOFCs)) for the production of a variety of products, such as fuel gases (using SOEC) and electricity (using SOFC). Advantageously, the electrode compositions can be used as either a positive and/or negative electrode. In one example, the electrode compositions described herein can be used to prepare symmetrical solid oxide electrochemical cells. The present disclosure also relates to various electrodes, solid oxide electrolysis cells, solid oxide fuel cells, processes, systems, generators, sensors, and/or reactors, which can utilise the electrode compositions.

In one aspect, there is provided an electrode composition comprising a plurality of hybrid electrode particles, wherein each hybrid electrode particle comprises at least one metallic phase and one oxide phase, wherein the metallic phase comprises a plurality of metallic particles and the oxide phase comprises a plurality of ion or mixed ion conducting oxide particles on the surface of the metallic particle(s), and wherein each hybrid electrode particle comprises a plurality of ion or mixed ion conducting oxide particles on the surface of a metallic particle, wherein the particle size (in nm) of the ion or mixed ion conducting oxide particles on the surface of the metallic particle is between about 1 to 200.

In another aspect, there is provided an electrode composition comprising a plurality of hybrid electrode particles, wherein each hybrid electrode particle comprises at least one metallic phase and one oxide phase, wherein the metallic phase comprises a plurality of metallic particles and the oxide phase comprises a plurality of ion or mixed ion conducting oxide particles on the surface of the metallic particle(s), wherein the plurality of ion or mixed ion conducting oxide particles are decorated on the surface of the metallic particle(s), and wherein the particle size (in nm) of the ion or mixed ion conducting oxide particles on the surface of the metallic particle is between about 1 to 100.

In some embodiments, the metallic phase comprises at least one metallic particle selected from silver (Ag), iron (Fe), nickel (Ni) and cobalt (Co). In other embodiments, the metallic phase comprises a combination of silver (Ag) particles and one or more of iron (Fe), nickel (Ni), cobalt (Co), Copper (Cu), and titanium (Ti). In some embodiments, the oxide phase comprises ion or mixed ion conducting oxide particles selected from metal (e.g. Gd, Sm, Pr, Ni) doped ceria, metal (e.g. Cu) doped ferrites, doped lanthanum strontium ferrite (e.g. LSCF, LSTF), and lanthanum strontium chromium manganese (LSCM).

In another aspect, there is provided an electrode composition comprising a plurality of hybrid electrode particles, wherein each hybrid electrode particle comprises a silver particle having a surface comprising one or more metal doped ceria particles.

In another aspect, there is provided an electrode composition comprising a plurality of hybrid electrode particles, wherein each hybrid electrode particle comprises a silver particle having a surface comprising one or more metal doped ceria particles, wherein the one or more metal doped ceria particles are decorated on the surface of the silver particle.

In another aspect, there is provided an electrode composition comprising a plurality of hybrid electrode particles, wherein each hybrid electrode particle comprises a silver particle having a surface comprising one or more metal doped ceria particles, wherein the particle size of the silver particles are greater than the particle size of the metal doped ceria particles.

In another aspect, there is provided an electrode composition comprising a plurality of hybrid electrode particles, wherein each hybrid electrode particle comprises a silver particle having a surface comprising one or more metal doped ceria particles, wherein the one or more metal doped ceria particles are decorated on the surface of the silver particle and the particle size of the silver particles are greater than the particle size of the metal doped ceria particles.

In another aspect, there is provided an electrode composition comprising a plurality of hybrid electrode particles, wherein each hybrid electrode particle comprises a silver particle having a surface comprising one or more ion or mixed ion conducting oxide particles, wherein the one or more ion or mixed ion conducting oxide particles are decorated on the surface of the silver particle, and the ion or mixed ion conducting oxide particles on the surface of the silver particle have a particle size (in nm) of between about 1 to 100.

In another aspect, there is provided an electrode composition comprising a plurality of hybrid electrode particles, wherein each hybrid electrode particle comprises a silver particle having a surface comprising one or more metal doped ceria particles, wherein the hybrid electrode particles have a particle size (in μm) of between about 0.05 to 5, and the metal doped ceria particles on the surface of the silver particle have a particle size (in nm) of between about 1 to 200.

In another aspect, there is provided an electrode composition comprising a plurality of hybrid electrode particles, wherein each hybrid electrode particle comprises a silver particle having a surface comprising one or more metal doped ceria particles, wherein the hybrid electrode particles have a particle size (in μm) of between about 0.05 to 5, and the metal doped ceria particles on the surface of the silver particle have a particle size (in nm) of between about 1 to 100.

In another aspect, there is provided an electrode composition comprising a plurality of hybrid electrode particles, wherein each hybrid electrode particle comprises a silver particle having a surface comprising one or more metal doped ceria particles, wherein the one or more metal doped ceria particles are decorated on the surface of the silver particle, and wherein the hybrid electrode particles have a particle size (in μm) of between about 0.05 to 5, and the metal doped ceria particles on the surface of the silver particle have a particle size (in nm) of between about 1 to 100.

In another aspect, there is provided an electrode composition comprising a plurality of hybrid electrode particles, wherein each hybrid electrode particle comprises a silver particle having a surface comprising one or more metal doped ceria particles, wherein the particle size of the silver particles are greater than the particle size of the metal doped ceria particles, and wherein the hybrid electrode particles have a particle size (in μm) of between about 0.05 to 5, and the metal doped ceria particles on the surface of the silver particle have a particle size (in nm) of between about 1 to 100.

In another aspect, there is provided an electrode composition comprising a plurality of hybrid electrode particles, wherein each hybrid electrode particle comprises a silver particle having a surface comprising one or more metal doped ceria particles, wherein the one or more metal doped ceria particles are decorated on the surface of the silver particle and the particle size of the silver particles are greater than the particle size of the metal doped ceria particles, and wherein the hybrid electrode particles have a particle size (in μm) of between about 0.05 to 5, and the metal doped ceria particles on the surface of the silver particle have a particle size (in nm) of between about 1 to 100.

In another aspect, there is provided a modified sol-gel process for preparing hybrid electrode particles, wherein each hybrid electrode particle comprises at least one metallic phase and one oxide phase, wherein the metallic phase comprises at least one metallic particle and the oxide phase comprises a plurality of ion or mixed ion conducting oxide particles on the surface of a metallic particle, wherein the plurality of ion or mixed ion conducting oxide particles are decorated on the surface of the metallic particle, wherein the particle size (in nm) of the ion or mixed ion conducting oxide particles on the surface of the metallic particle is between about 1 to 100, wherein the process comprises:
a) preparing a gel from an aqueous solution comprising a metallic species, an ion or mixed ion conducting oxide species, a plasticizer, and a chelating agent; and
b) heating the gel to obtain a powder composition comprising the hybrid electrode particles.

In another aspect, there is provided a modified sol-gel process for preparing hybrid electrode particles, wherein the process comprises:
a) preparing a gel from an aqueous solution comprising a silver metal species, a cerium metal species, a metal dopant species, a plasticizer, and a chelating agent; and
b) heating the gel to obtain a powder composition comprising the hybrid electrode particles.

In another aspect, there is provided a modified sol-gel process for preparing hybrid electrode particles, wherein the process comprises:
a) preparing a gel from an aqueous solution comprising a bimetallic metal species, a cerium metal species, a metal dopant species, a plasticizer, and a chelating agent; and
b) heating the gel to obtain a powder composition comprising the hybrid electrode particles.

In another aspect, there is provided a modified sol-gel process for preparing hybrid electrode particles, wherein the process comprises:
a) preparing a gel from an aqueous solution comprising a bimetallic metal species, a metal doped ferrite, a plasticizer, and a chelating agent; and
b) heating the gel to obtain a powder composition comprising the hybrid electrode particles.

In another aspect, there is provided an electrode comprising the electrode composition described herein, or a sintered electrode material thereof.

In another aspect, there is provided a solid oxide electrochemical cell comprising a cathode, a solid oxide electrolyte, and an anode, wherein the cathode and/or the anode comprise the electrode composition described herein, or a sintered electrode material thereof.

In another aspect, there is provided a use of the electrode composition described herein in preparing an electrode or electrode material for a solid oxide electrochemical cell.

In another aspect, there is provided a method of manufacturing a solid oxide electrochemical cell comprising:
a) preparing one or more solid oxide electrolyte layers;
b) applying an electrode composition to one or both sides of the solid oxide electrolyte layer(s) to form a solid oxide electrochemical cell component, wherein the electrode composition applied to at least one side of the solid oxide electrolyte layer(s) comprises an electrode composition described herein; and
c) sintering the electrode composition applied onto the solid oxide electrochemical cell component to form an electrode or electrode material.

It will be appreciated that any one or more of the embodiments and examples described herein for the electrode composition or sintered electrode material thereof may also apply to the electrodes, solid oxide electrolysis cells, solid oxide fuel cells, processes, systems, generators, sensors, and/or reactors described herein. Any embodiment herein shall be taken to apply mutatis mutandis to any other embodiment unless specifically stated. It will also be appreciated that other aspects, embodiments and examples of the electrode composition or sintered electrode material thereof, electrodes, solid oxide electrolysis cells, solid oxide fuel cells, processes, systems, generators, sensors, and/or reactors are described herein.

It will also be appreciated that some features of the electrode composition or sintered electrode material thereof, electrodes, solid oxide electrolysis cells, solid oxide fuel cells, processes, systems, generators, sensors, and/or reactors identified in some aspects, embodiments or examples as described herein may not be required in all aspects, embodiments or examples as described herein, and this specification is to be read in this context. It will also be appreciated that in the various aspects, embodiments or examples, the order of method or process steps may not be essential and may be varied.

### BRIEF DESCRIPTION OF THE DRAWINGS

Preferred embodiments of the present disclosure are further described and illustrated as follows, by way of example only, with reference to the accompanying drawings in which:

FIG. 1: Schematic of a hybrid electrode particle comprising a metal particle decorated with one or more mixed ionic conducting phase/metal oxide phase.

FIG. 2: Schematic of an electrode composition comprising a plurality of hybrid electrode particles provided as a layer on an electrolyte provided for an anode in solid oxide electrolysis mode.

FIG. 3: Schematic of an electrode composition comprising a plurality of hybrid electrode particles provided as a layer on an electrolyte provided for a cathode of solid oxide electrolysis mode.

FIG. 4: Scanning electron microscopy image of a sintered electrode material comprising a silver metal phase and one or more metal doped ceria particles or discrete portions interspersed within the silver metal phase.

FIG. 5: Energy Dispersive Spectroscopy (EDS) layered image of a sintered electrode material comprising a silver metal phase and one or more metal doped ceria particles or discrete portions interspersed within the silver metal phase.

FIG. 6: Current-voltage curves of a tubular solid oxide electrolysis cell using as electrodes—a sintered material comprising a silver metal phase and one or more metal doped ceria particles or discrete portions interspersed within the silver metal phase; Ni—YSZ composite; or mixed CGO-AG, for steam electrolysis.

FIG. 7: Current-voltage curves of a tubular symmetrical solid oxide electrolysis cell using a sintered electrode material comprising a silver metal phase and one or more mixed ionic and electronic conductor ferrite phase (LSCF) or discrete portions interspersed within the silver metal phase; mixed Ag-LSCF, for steam electrolysis.

FIG. 8: Current-voltage curves of a tubular unsymmetrical solid oxide electrolysis cell using a sintered electrode material comprising one or more metal phases and one or more metal doped ceria particles or discrete portions interspersed within the metal phase; mixed Fe—Ag-GDC for steam electrolysis.

FIG. 9: Electrode Polarization resistance of a tubular symmetrical solid oxide electrolysis cell using a sintered electrode material comprising a silver metal phase and one or more metal doped ceria particles or discrete portions interspersed within the silver metal phase; mixed Ag-GDC, for steam electrolysis.

FIG. 10: Short term performance of steam electrolysis using a tubular solid oxide electrolysis cell using as electrodes a sintered material comprising a silver metal phase and one or more metal doped ceria particles or discrete portions interspersed within the silver metal phase.

FIG. 11: Schematic of tube-cell set up using one or more electrodes comprising sintered hybrid electrode material according to some embodiments or examples described herein.

### DETAILED DESCRIPTION

The present disclosure describes the following various non-limiting embodiments, which relate to investigations undertaken to identify electrode compositions. Additional non-limiting embodiments, of the electrode compositions, electrodes, solid oxide electrochemical cells, solid oxide fuel cells, processes, systems, generators, sensors, and/or reactors are also described. Solid oxide fuel cells (SOFC) can convert chemical energy in the fuels (such as hydrogen, hydrocarbon fuels, ammonia, methane, etc.) into electricity with high efficiency, and solid oxide electrolysis cells (SOEC) can store the electricity from “excess” renewable energy in the form of chemical fuels (such as CO, H₂, syngas, and other hydrocarbon fuels) through the electrolysis of molecules like H₂O, CO₂ and N₂. In other words, a solid oxide electrolysis cell (SOEC) can be used to store the excess energy in fuel form when the renewable source is higher than demand. The stored fuel can then be used for combined heat and power applications by a solid oxide fuel cell (SOFC). This implies that a reversible solid oxide cell (RSOC) that can produce synthetic fuel from electricity or produce electricity from fuel when reversed could be desirable.

The electrode compositions described herein comprise a plurality of hybrid electrode particles, which is further described below according to various non-limiting embodiments and examples. It has been surprisingly found that the electrode compositions described herein provides one or more advantages including for the synthesis of a variety of products, such as fuel gases. At least according to some embodiments or examples described herein, the electrode compositions can advantageously be used as both the positive and the negative electrode of solid oxide electrochemical cells. It has been found that such symmetrical solid oxide electrochemical cells can lead to faster manufacturing times, and therefore scalable and effective industrial processes for preparing solid oxide electrochemical cells. Other applications and advantages associated with the electrode compositions are also described herein.

### Terms

In the following description, reference is made to the accompanying drawings which form a part hereof, and which is shown, by way of illustration, several embodiments. It is understood that other embodiments may be utilized and structural changes may be made without departing from the scope of the present disclosure.

With regards to the definitions provided herein, unless stated otherwise, or implicit from context, the defined terms and phrases include the provided meanings. Unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, coatings, processes, and coated substrates, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

As used herein, the term “about”, unless stated to the contrary, typically refers to +/−10%, for example +/−5%, of the designated value.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The reference to “substantially free” generally refers to the absence of that compound or component in the composition other than any trace amounts or impurities that may be present, for example this may be an amount by weight % in the total composition of less than about 1%, 0.1%, 0.01%, 0.001%, or 0.0001%.

Herein “weight %” may be abbreviated to “wt %”.

### Electrode Compositions

The present disclosure is directed to providing improvements in electrode compositions including improved stability and performance. The present disclosure covers various research and development directed to identifying electrode compositions for use in the preparation of electrodes, including those used for solid oxide electrochemical cells (e.g. solid oxide electrolysis cells (SOECs) and solid oxide fuel cells (SOFCs)). One or more advantages of the present disclosure according to at least some embodiments or examples as described herein is that the electrode compositions can be used as either a positive and/or a negative electrode. In one example, the electrode composition can be used to prepare symmetrical solid oxide cells, such as symmetrical SOECs and symmetrical SOFCs.

The SOECs described here can advantageously be used for production of fuel gases such as (1) hydrogen from steam electrolysis, (2) carbon monoxide from carbon dioxide electrolysis, (3) synthetic gas, also referred to as “syngas”, from the electrolysis of the mixture of steam and CO₂, (4) ammonia production from the electrolysis of mixture of steam and nitrogen, and (5) synthetic methane production from the electrolysis of mixture of steam and CO₂. The fuel gases produced can be used in a variety of chemical processes or energy production. The SOECs described herein can also be integrated with downstream fuel and chemical production processes enabling renewable energy storage and export in form of value added chemical and fuels. The SOEC can also use high temperature (e.g. >600° C.) to electrolyse steam/CO₂ with high efficiency assisted by thermodynamically favoured steam/CO₂ splitting that can enable large-scale hydrogen/CO/Syngas/ammonia/methane production. One or more advantages of the present disclosure according to at least some embodiments or examples as described herein is that with the fabrication of commercial scale SOECs the technology is increasingly viewed as a mean to produce sustainable fuels using renewable energy.

It has been found that the electrode compositions comprising a mixture of two or more phases can provide for numerous reaction sites both within and on the surface of the catalyst composition at the interface (i.e. phase boundary) between the two phases. Unexpectedly, the resulting microstructure of the electrode compositions can provide one or more advantages according to at least some embodiments or examples described herein, including improved catalytic performance of SOECs. Other advantages provided by the electrode compositions are also described herein.

The electrode compositions may comprise a plurality of hybrid particles. The hybrid electrode particle comprises at least one metallic phase and one metal oxide phase. In embodiments, the metallic phase may comprise a plurality of metallic particles and the oxide phase comprises a plurality of ion or mixed ion conducting oxide particles on the surface of the metallic particle(s). Each hybrid electrode particle may comprise one or more metallic particles and one or more ion or mixed ion conducting oxide particles. The oxide particle may be doped with one or more additional metals. The metallic particle has a surface which may comprise the one or more oxide particles. Each hybrid electrode particle may comprise a metallic particle having a surface comprising one or more ion or mixed ion conducting oxide particles. It will be appreciated that the one or more or plurality of ion or mixed ion conducting oxide particles are decorated on the surface of the metallic particle. In other words, one or more advantages according to at least some embodiments or examples as described herein may be provided by the plurality of ion or mixed ion conducting oxide particles being decorated on the surface of the metallic particle as spacing between the ion or mixed ion conducting oxide particles allow free space on the metallic particles to form a connecting network of metallic particles to achieve the advantageous electronic conductivity in the resulting electrode structure and lower the polarization losses.

The metallic phase may comprise at least one metallic particle selected from silver (Ag), iron (Fe), nickel (Ni) and cobalt (Co). In some embodiments, the metallic phase may comprise a combination of silver (Ag) particles and one or more of iron (Fe), nickel (Ni), cobalt (Co), copper (Cu), and titanium (Ti). In one example, the metallic phase may comprise a combination of silver (Ag) particles and iron (Fe) particles. In other examples, the metallic phase may comprise silver (Ag) particles. The oxide phase may comprise ion or mixed ion conducting oxide particles selected from metal (e.g. Gd, Sm, Pr, Ni) doped ceria, metal (e.g. Cu, Ti, Co) doped ferrites, and lanthanum strontium chromium manganese (LSCM). The hybrid electrode particle may comprise a silver particle and one or more ion or mixed ion conducting oxide particles. The silver particle has a surface which may comprise one or more metal oxide particles. The hybrid electrode particle may comprise a silver particle and one or more ceria particles. The ceria particles may be doped with one or more metals. The silver particle has a surface which may comprise one or more metal doped ceria particles. In one embodiment, there is provided an electrode composition comprising a plurality of hybrid electrode particles.

### Hybrid Electrode Particles

In some embodiments, the electrode composition comprises a plurality of hybrid electrode particles. As used herein, the term “hybrid electrode particle” refers to a single particle that comprises at least two phases, for example at least one metallic phase (e.g. silver) and at least one metal oxide phase (e.g. ceria).

In one embodiment, the hybrid electrode particles may be any morphology, for example may take the form of flakes, fibres, agglomerates, granules, powders, spheres, pulverized materials or the like, as well as combinations thereof. The hybrid electrode particles may have any desired shape including, but not limited to, cubic, rod like, polyhedral, spherical or semi-spherical, rounded or semi-rounded, angular, irregular, and so forth. In one embodiment, the hybrid electrode particles have an aspect ratio (i.e. the ratio of a length to a width, where the length and width are measured perpendicular to one another, and the length refers to the longest linearly measured dimension) of 1.0 to 10.0, 1.0 to 5.0, or 1.0 to 2.0. In one embodiment, the hybrid electrode particles may have an aspect ratio of about 1.0 to 2.0, for example about 1.0, 1.1, 1.2, 1.3, 1.4, 1.5, 1.6, 1.7, 1.8, 1.9, or 2.0.

In some embodiments, the particle size (in μm) of the hybrid electrode particles may be at least about 0.05, 0.06, 0.07, 0.08, 0.09, 0.1, 0.2, 0.5, 0.7, 1, 1.5, 2, 2.5, 3, 3.5, 4, or 5. In some embodiments, the particle size (in μm) of the hybrid electrode particles may be less than about 5, 4, 3.5, 3, 2.5, 2, 1.5, 1, 0.7, 0.5, 0.2, 0.1, 0.09, 0.08, 0.07, 0.06 or 0.05. Combinations of any two or more of these upper and/or lower particle sizes are also possible, for example the particle size (in μm) of the hybrid electrode particles may be between about 0.05 to 5, 0.06 to 4, or 0.07 to 3.5. The particle size is taken to be the longest cross-sectional diameter across a hybrid electrode particle. For non-spherical hybrid electrode particles, the particle size is taken to be the distance corresponding to the longest cross-section dimension across the particle.

The hybrid electrode particles may have a particle size distribution from 0 to 100% in the range of 0.05-5 μm or vice versa. For example, 80% of particle size will be in the range of 0.05-3 μm and 20% of the particle size in the range of 3-5 μm. Other percentages with combination of upper and/or lower particle sizes are also possible.

The particle size and/or particle size distribution can be measured by any standard method, for example laser diffraction, electron microscopy (e.g. TEM or SEM), X-ray diffraction (e.g. Scherrer equation), or dynamic light scattering. In one embodiment, the particle size and/or particle size distribution can be measured using laser diffraction according to industry standard ISO 13320:2020.

### Metallic Particles

The metallic particle of the hybrid electrode particle may comprise at least one metallic particle selected from silver (Ag), iron (Fe), nickel (Ni) and cobalt (Co). In some embodiments, the metallic particle may comprise a combination of silver (Ag) particles and one or more of iron (Fe), nickel (Ni), cobalt (Co), Copper (Cu), and titanium (Ti). In other embodiments, the metallic particle of the hybrid electrode particle may comprise a combination of silver (Ag) particles and iron (Fe) particles. It will be appreciated that the hybrid electrode particle comprises a silver (Ag) particle which has a high electrical conductivity which can assist in the transfer of electrons across the hybrid electrode particle and consequently throughout the electrode composition.

In one embodiment, the metallic particle of each hybrid electrode particle may be any morphology, for example may take the form of flakes, fibres, agglomerates, granules, powders, spheres, pulverized materials or the like, as well as combinations thereof. The metallic particle of each hybrid electrode particle may have any desired shape including, but not limited to, cubic, rod like, polyhedral, spherical or semi-spherical, rounded or semi-rounded, angular, irregular, and so forth. In one embodiment, the metallic particle of each hybrid electrode particle may have an aspect ratio (i.e. the ratio of a length to a width, where the length and width are measured perpendicular to one another, and the length refers to the longest linearly measured dimension) of 1.0 to 10.0, 1.0 to 5.0, or 1.0 to 2.0. In one embodiment, the metallic particle of each hybrid electrode particle may have an aspect ratio of about 1.0 to 2.0, for example about 1.0, 1.1, 1.2, 1.3, 1.4, 1.5, 1.6, 1.7, 1.8, 1.9, or 2.0.

In some embodiments, the metallic particle of each hybrid electrode particle has a particle size (in μm) of at least about 0.01, 0.05, 0.1, 0.2, 0.5, 0.7, 1, 1.5, 2, 2.5, 3, 3.5, 4 or 5. In some embodiments, the metallic particle of each hybrid electrode particle has a particle size (in μm) of less than about 5, 4, 3.5, 3, 2.5, 2, 1.5, 1, 0.7, 0.5, 0.2, 0.1, 0.05 or 0.01. Combinations of any two or more of these upper and/or lower particle sizes are also possible. In some embodiments, the silver particle of each hybrid electrode particle has a particle size (in μm) of at least about 0.01, 0.05, 0.1, 0.2, 0.5, 0.7, 1, 1.5, 2, 2.5, 3, 3.5, 4 or 5. In some embodiments, the silver particle of each hybrid electrode particle has a particle size (in μm) of less than about 5, 4, 3.5, 3, 2.5, 2, 1.5, 1, 0.7, 0.5, 0.2, 0.1, 0.05 or 0.01. Combinations of any two or more of these upper and/or lower particle sizes are also possible, for example the silver particle of each hybrid electrode particle has a particle size (in μm) of between about 0.01 to 5, 0.05 to 5, 0.01 to 4 or 0.05 to 4. The particle size is taken to be the longest cross-sectional diameter across a metallic particle. For non-spherical metallic particles, the particle size is taken to be the distance corresponding to the longest cross-section dimension across the particle. The particle size of the metallic particles of each hybrid electrode particle can be measured by electron microscopy (e.g. TEM or SEM) or X-ray diffraction (e.g. Scherrer analysis of one or more diffraction peaks).

In some embodiments, the total amount of metallic particles in the hybrid electrode particles (in % w/w based on the total weight of hybrid electrode particles) is at least 10, 15, 20, 30, 35, 40, 45, 50, 55, 60, 65, 70, 75, or 80. In some embodiments, the total amount of metallic particles in the hybrid electrode particles (in % w/w based on the total weight of hybrid electrode particles) is less than about 80, 75, 70, 65, 60, 55, 50, 45, 40, 35, 30, 25, 20, 15 or 10. Combinations of any two or more of these upper and/or lower amounts are also possible. In some embodiments, the total amount of silver in the hybrid electrode particles (in % w/w based on the total weight of hybrid electrode particles) is at least 10, 15, 20, 30, 35, 40, 45, 50, 55, 60, 65, 70, 75 or 80. In some embodiments, the total amount of silver in the hybrid electrode particles (in % w/w based on the total weight of hybrid electrode particles) is less than about 80, 75, 70, 65, 60, 55, 50, 45, 40, 35, 30, 25, 20, 15 or 10. Combinations of any two or more of these upper and/or lower amounts are also possible, for example, the total amount of silver in the hybrid electrode particles may be between about 40% w/w to 75% w/w. In some embodiments, the total amount of silver in the hybrid electrode particles (in % w/w based on the total weight of the hybrid electrode particles) is about 10, 15, 20, 30, 35, 40, 45, 50, 55, 60, 65, 70, 75, or 80. The amount of metal and metal doped ceria in the hybrid electrode particles may be determined using electron microscopy, including energy dispersive X-ray spectroscopy (EDS).

### Ion or Mixed Ion Conducting Oxide Particles

The oxide phase may comprise ion or mixed ion conducting oxide particles selected from metal (e.g. Gd, Sm, Pr, Ni) doped ceria, metal (e.g. Cu) doped ferrites, doped lanthanum strontium ferrite (e.g. LSCF, LSTF), and doped lanthanum strontium chromate (e.g. LSCM).

By introducing a metal dopant into ceria, one or more oxygen vacancies are created. The high concentration and mobility of the oxide ion vacancies results in the metal doped ceria particles having a high mixed ionic and electronic conductivity. For example, the silver particle has a surface which may comprise one or more metal doped ceria particles (also referred to as cerium (IV) oxide (CeO₂)).

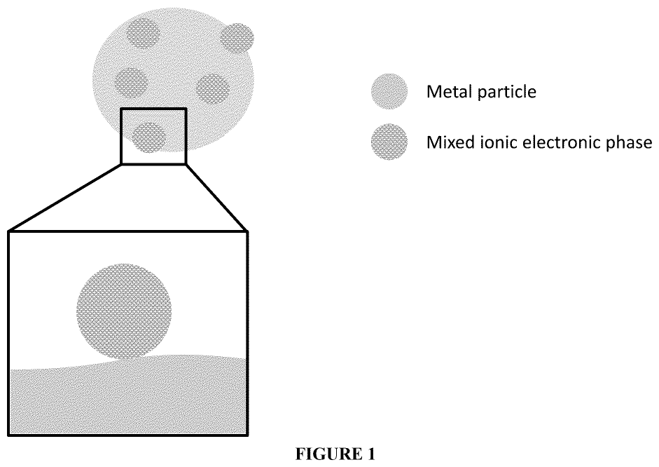

In one embodiment, the metallic particle (e.g. silver) has a surface comprising a plurality of ion or mixed ion conducting oxide particles. The metallic particle can act as a support/scaffold for the plurality of ion or mixed ion conducting oxide particles. It will be appreciated that the hybrid electrode particle is a single particle and not a mere mixture of separate metallic particles and ion or mixed ion conducting oxide particles. It will be understood that each hybrid electrode particle comprises a metallic particle and plurality of ion or mixed ion conducting oxide particles which are provided (i.e. decorated) on the surface of the metallic particle. In other words, the plurality of ion or mixed ion conducting oxide particles are interspersed, incorporated or embedded on the surface of the metallic particle, and not provided as independent particles in the composition. For example, the one or more metal doped ceria particles are decorated on the surface of the silver particle. In other words, one or more advantages according to at least some embodiments or examples as described herein may be provided by the plurality of ion or mixed ion conducting oxide particles (e.g. metal doped ceria particles) being decorated on the surface of the metallic particle (e.g. silver particle) as spacing between the ion or mixed ion conducting oxide particles allow free space on the metallic particles to form a connecting network of metallic particles to achieve the advantageous electronic conductivity in the resulting electrode structure and lower the polarization losses. Referring to FIG. 1, an example of a hybrid electrode particle is shown comprising a single metallic (e.g. silver) particle, wherein one or more ion or mixed ion conducting oxide particles (e.g. metal doped ceria nanoparticles) are provided on the surface of the metallic (e.g. silver) particle, thereby forming a hybrid particle. For example, the particle size of the metallic (silver) particles may be greater than the particle size of the ion or mixed ion conducting oxide particles.

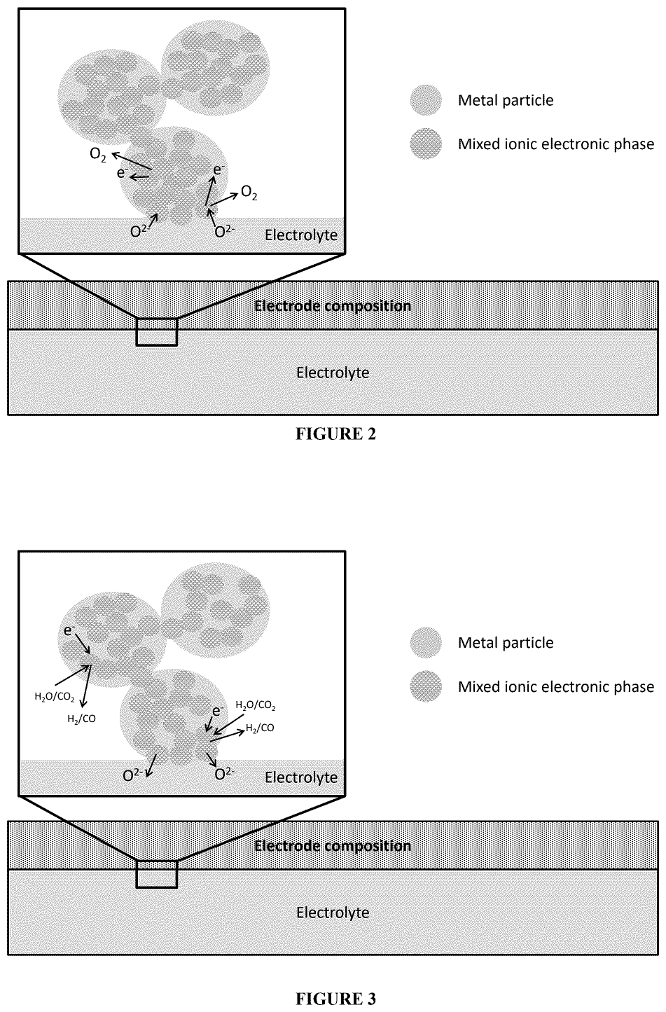

Without wishing to be bound by theory, the junction at the interface between the metallic surface and ion or mixed ion conducting oxide particle provides for a plurality of reactive sites on each hybrid electrode particle. For example, silver particles and metal doped ceria particles on each hybrid electrode particle can promote the transport of electrons and/or mobile oxygen species (O²⁻), respectively, both to and from the reactive sites located on the surface of each hybrid electrode particle, for example when used as electrode compositions in SOECs or SOFCs. Owing to the unique microstructure of the hybrid electrode particles, an ionic and electronic pathway is created to transfer electrons and mobile oxygen species (O²⁻) to and from the reactive sites located on the surface of each hybrid electrode particle. The location of one reactive site is provided by way of example in FIGS. 2 and 3 (magnification) for an electrode composition comprising the hybrid electrode particles when used as an oxygen and fuel electrode of a solid oxide electrolysis cell (SOEC).

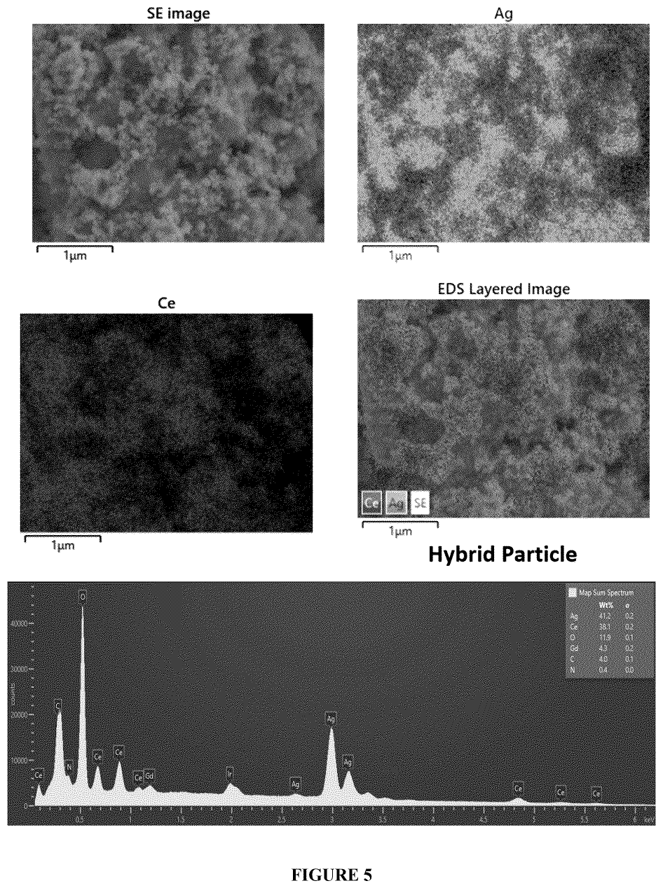

In some embodiments, at least 5, 10, 15, 20, 25, 30, 35, 40, 45, or 50% of the surface of the metallic particle of each hybrid electrode particle may comprise ion or mixed ion conducting oxide particles. In some embodiments, less than 95, 90, 85, 80, 75, 70, 65, 60, 55, or 50% of the surface of the metallic particle of each hybrid electrode particle may comprise ion or mixed ion conducting oxide particles. The plurality of ion or mixed ion conducting oxide (e.g. metal doped ceria) particles may be irregularly spaced across the surface of the metallic (e.g. silver) particle. It will be appreciated that the irregular spacing across the surface of the metallic particle(s) creates free space across the surface to form a connecting network of metallic particles providing one or more advantages according to at least some embodiments or examples as described herein. The amount of ion or mixed ion conducting oxide particles present on the surface of the metallic particles may be determined using electron microscopy, including energy dispersive X-ray spectroscopy (EDS) in scanning transmission electron microscopy (STEM). An example of this is shown in FIG. 5.

In one embodiment, the ion or mixed ion conducting oxide (e.g. metal doped ceria) particles of each hybrid electrode particle may be any morphology, for example may take the form of flakes, fibres, agglomerates, granules, powders, spheres, pulverized materials or the like, as well as combinations thereof. The ion or mixed ion conducting oxide (e.g. metal doped ceria) particles of each hybrid electrode particle may have any desired shape including, but not limited to, cubic, rod like, polyhedral, spherical or semi-spherical, rounded or semi-rounded, angular, irregular, and so forth. In one embodiment, the ion or mixed ion conducting oxide (e.g. metal doped ceria) particles of each hybrid electrode particle may have an aspect ratio (i.e. the ratio of a length to a width, where the length and width are measured perpendicular to one another, and the length refers to the longest linearly measured dimension) of 1.0 to 10.0, 1.0 to 5.0, or 1.0 to 2.0. In one embodiment, the ion or mixed ion conducting oxide (e.g. metal doped ceria) particles of each hybrid electrode particle may have an aspect ratio of about 1.0 to 2.0, for example the metal doped ceria particles may gave an aspect ratio of about 1.0, 1.1, 1.2, 1.3, 1.4, 1.5, 1.6, 1.7, 1.8, 1.9, or 2.0.

In some embodiments, the ion or mixed ion conducting oxide particles of each hybrid electrode particle has a particle size (in nm) of at least about 1, 2, 5, 10, 25, 50, 75, 100, 125, 150, 175 or 200. In some embodiments, the ion or mixed ion conducting oxide particles of each hybrid electrode particle has a particle size (in nm) of less than about 200, 175, 150, 125, 100, 75, 50, 25, 10, 5, 2 or 1. Combinations of any two or more of these upper and/or lower particle sizes are also possible, for example the ion or mixed ion conducting oxide particles of each hybrid electrode particle has a particle size (in nm) of between about 1 to 200, 10 to 150 or 15 to 100. For example the ion or mixed ion conducting oxide particles of each hybrid electrode particle has a particle size (in nm) of less than about 200, preferably less than about 100. In some embodiments, the metal doped ceria particles of each hybrid electrode particle has a particle size (in nm) of at least about 1, 2, 5, 10, 25, 50, 75, 100, 125, 150, 175 or 200. In some embodiments, the metal doped ceria particles of each hybrid electrode particle has a particle size (in nm) of less than about 200, 175, 150, 125, 100, 75, 50, 25, 10, 5, 2 or 1. Combinations of any two or more of these upper and/or lower particle sizes are also possible, for example the metal doped ceria particles of each hybrid electrode particle has a particle size (in nm) of between about 1 to 200, 10 to 150 or 15 to 100. In preferred embodiments, the ion or mixed ion conducting oxide particles of each hybrid electrode particle has a particle size (in nm) of less than about 100. The particle size is taken to be the longest cross-sectional diameter across an oxide particle. For non-spherical ion or mixed ion conducting oxide particles, the particle size is taken to be the distance corresponding to the longest cross-section dimension across the particle. The particle size of the ion or mixed ion conducting oxide particles of each hybrid electrode particle can be measured by electron microscopy (e.g. TEM or SEM) or X-ray diffraction (e.g. Scherrer analysis of one or more diffraction peaks).

In some embodiments, the total amount of ion or mixed ion conducting oxide in the hybrid electrode particles (in % w/w based on the total weight of hybrid electrode particles) is at least 20, 30, 35, 40, 45, 50, 55, 60, 65, 70, 75 or 80. In some embodiments, the total amount of ion or mixed ion conducting oxide in the hybrid electrode particles is less than about 80, 75, 70, 65, 60, 55, 50, 45, 40, 35, 30, 25 or 20. Combinations of any two or more of these upper and/or lower amounts are also possible, for example, the total amount of ion or mixed ion conducting oxide in the hybrid electrode particles may be between about 20% w/w to 50% w/w, or about 25% to 45% w/w. In some embodiments, the total amount of ceria in the hybrid electrode particles (in % w/w based on the total weight of hybrid electrode particles) is at least 20, 30, 35, 40, 45, 50, 55, 60, 65, 70, 75 or 80. In some embodiments, the total amount of ceria in the hybrid electrode particles is less than about 80, 75, 70, 65, 60, 55, 50, 45, 40, 35, 30, 25 or 20. Combinations of any two or more of these upper and/or lower amounts are also possible, for example, the total amount of ceria in the hybrid electrode particles may be between about 20% w/w to 50% w/w, or about 25% to 45% w/w.

In some embodiments, the total amount of metal in the hybrid electrode particles is between about 20% w/w to 80% w/w, and the total amount of oxide in the hybrid electrode particles is between about 20% w/w to 50% w/w. In some embodiments, the total amount of metal in the hybrid electrode particles is between about 55% w/w to 75% w/w, and the total amount of oxide in the hybrid electrode particles is between about 25% w/w to 45% w/w.

In some embodiments, the total amount of silver in the hybrid electrode particles is between about 20% w/w to 80% w/w, and the total amount of ceria in the hybrid electrode particles is between about 20% w/w to 50% w/w. In some embodiments, the total amount of silver in the hybrid electrode particles is between about 55% w/w to 75% w/w, and the total amount of ceria in the hybrid electrode particles is between about 25% w/w to 45% w/w.

In some embodiments, the % w/w ratio of metal to oxide in the hybrid electrode particle is at least 1:10, 1:5, 1:4, 1:3, 1:2, 1:1, 2:1, 3:1, 4:1, 5:1, or 10:1. In some embodiments, the % w/w ratio of metal to oxide in the hybrid electrode particle is less than 10:1, 5:1, 4:1, 3:1, 2:1, 1:1, 1:2, 1:3, 1:4, 1:5, or 10:1. Combinations of any two or more of these upper and/or lower amounts are also possible, for example, the % w/w ratio of metal to oxide in the hybrid electrode particle may be between about 1:5 to about 5:1, or about 1:2 to about 1:1. In some embodiments, the % w/w ratio of silver to ceria in the hybrid electrode particle is at least 1:10, 1:5, 1:4, 1:3, 1:2, 1:1, 2:1, 3:1, 4:1, 5:1, or 10:1. In some embodiments, the % w/w ratio of silver to ceria in the hybrid electrode particle is less than 10:1, 5:1, 4:1, 3:1, 2:1, 1:1, 1:2, 1:3, 1:4, 1:5, or 10:1. Combinations of any two or more of these upper and/or lower amounts are also possible, for example, the % w/w ratio of silver to ceria in the hybrid electrode particle may be between about 1:5 to about 5:1, or about 1:2 to about 1:1.

It will be appreciated that the plurality of ion or mixed ion conducting oxide particles may be doped with one or more metal species. For example, the ceria particles may be doped with gadolinium (Gd), samarium (Sm), praseodymium (Pr) or nickel (Ni). In another example, ferrite can be doped with titanium (Ti), Cobalt (Co) and Copper (Cu) or lanthanum strontium chromate can be doped with Manganese (Mn), Calcium (Ca), Bismuth (Bi), Copper (Cu), Ruthenium (Ru). The one or more ceria particles may be doped with one or more metal species. The metal dopant may be provided by one or more metals selected from rare-earth metals and alkaline earth metals.

In some embodiments, the metal dopant for the oxide particles may be provided by one or more of samarium (Sm), gadolinium (Gd), lanthanum (La), zirconium (Zr), yttrium (Y), ytterbium (Yb), erbium (Er), praseodymium (Pr), nickel (Ni) or provided by one or more of gadolinium (Gd) samarium (Sm) and yttrium (Y). In one embodiment, the metal dopant is gadolinium (Gd). It will be appreciated that gadolinium, samarium and cerium have a similar ionic size and as such a high number of oxygen vacancies are created. It has been found that the high concentration and mobility of the oxide ion vacancies provides the ion or mixed ion conducting oxide (e.g. metal doped ceria) particles with an advantageously high ionic conductivity. However, it will also be appreciated that other metal dopants may also provide good ionic conductivity.

The metal dopant and oxide are a single phase. The ratio of metal dopant to oxide in the ion or mixed ion conducting oxide particles may be between about 100:1 to 2:1, about 50:1 to 3:1, or 20:1 to 4:1. The ratio of metal dopant to oxide in the ion or mixed ion conducting oxide particles may be at least about 2:1, 3:1, 4:1, 5:1, 10:1, 20:1, 50:1 or 100:1. The ratio of metal dopant to oxide in the ion or mixed ion conducting oxide particles may be less than about 100:1, 50:1, 20:1, 10:1, 5:1, 4:1, 3:1, or 2:1. In one example, the metal dopant and ceria are a single phase. The ratio of metal dopant to ceria in the metal doped ceria particles may be between about 100:1 to 2:1, about 50:1 to 3:1, or 20:1 to 4:1. The ratio of metal dopant to ceria in the metal doped ceria particles may be at least about 2:1, 3:1, 4:1, 5:1, 10:1, 20:1, 50:1 or 100:1. The ratio of metal dopant to ceria in the metal doped ceria particles may be less than about 100:1, 50:1, 20:1, 10:1, 5:1, 4:1, 3:1, or 2:1.

The amount of metal dopant present in the ceria particles can be defined by the formula Ce₁₋ₓMₓO_{2-δ} wherein x is between about 0.01 to 0.3, 0.02 to 0.25, or 0.05 to 0.2, M is one or more metal dopants as defined above, and δ is between about 0.0 and 0.5 or 0.1 to 0.4. Combinations of any two of these upper and/or lower values are also possible.

The amount of metal dopant in the oxide particles can vary. In some embodiments, the amount of metal dopant in the oxide particles (in % w/w based on total weight of ion or mixed ion conducting oxide particles) is at least about 1, 2, 5, 10, 15, 20, 25, 30, 40, or 50. In some embodiments, the amount of metal dopant in the oxide particles (in % w/w based on total weight of ion or mixed ion conducting oxide particles) is at least about 50, 40, 30, 25, 20, 15, 10, 5, 2, or 1. Combinations of any two or more of these upper and/or lower amounts are also possible, for example, the amount of metal dopant in the oxide particles may be between about 1% w/w to 35% w/w, about 2% w/w to 30% w/w, or 5% w/w to 25% w/w. In some embodiments, the amount of metal dopant in the oxide particles (in % w/w based on total weight of ion or mixed ion conducting oxide particles) is about 1, 2, 5, 10, 15, 20, 25, 30, 40, or 50. In some embodiments, the amount of metal dopant in the ceria particles (in % w/w based on total weight of metal doped ceria particles) is at least about 1, 2, 5, 10, 15, 20, 25, 30, 40, or 50. In some embodiments, the amount of metal dopant in the ceria particles (in % w/w based on total weight of metal doped ceria particles) is at least about 50, 40, 30, 25, 20, 15, 10, 5, 2, or 1. Combinations of any two or more of these upper and/or lower amounts are also possible, for example, the amount of metal dopant in the ceria particles may be between about 1% w/w to 35% w/w, about 2% w/w to 30% w/w, or 5% w/w to 25% w/w. In some embodiments, the amount of metal dopant in the ceria particles (in % w/w based on total weight of metal doped ceria particles) is about 1, 2, 5, 10, 15, 20, 25, 30, 40, or 50.

The electrode composition may further comprise one or more additives in addition to the hybrid electrode particles. In one embodiment, the electrode composition may further comprise a conductive additive. For example, a conductive additive may include one or more metallic additives such as nickel powder, titanium powder, stainless steel powder, and mixtures thereof.

### Sintered Electrode Material

The electrode composition may be provided as a sintered electrode material. As used herein, the term “sintered electrode material” refers to an electrode material produced by heating (e.g. firing) the electrode composition comprising the hybrid electrode particles so that the metallic particles of the hybrid electrode particles coalesce and adhere to each other, to form a continuous or semi-continuous metallic metal phase within the electrode material of solid oxide electrochemical cell.

The metallic phase may comprise one or more metal portions. In some embodiments, the metallic phase is a porous scaffold. In one embodiment, the silver metal phase may comprise one or more silver metal portions. In some embodiments, the silver metal phase is a porous scaffold. The porous nature facilitates mobile ion species transfer throughout the electrode material. Following sintering to form the metallic phase (i.e. a scaffold comprising the porous silver metal phase), the ion or mixed ion conducting oxide particles may remain as discrete particles attached to the surface of the metallic phase and/or may also adhere to other ion or mixed ion conducting oxide particles to form one or more discrete oxide phases (e.g. portions) attached to the surface of the metallic phase. In one embodiment, the sintered electrode material comprises a silver metal phase as a porous scaffold and plurality of discrete oxide phases interspersed within the silver metal phase. The discrete oxide phase may be in the form of metal doped ceria particles.

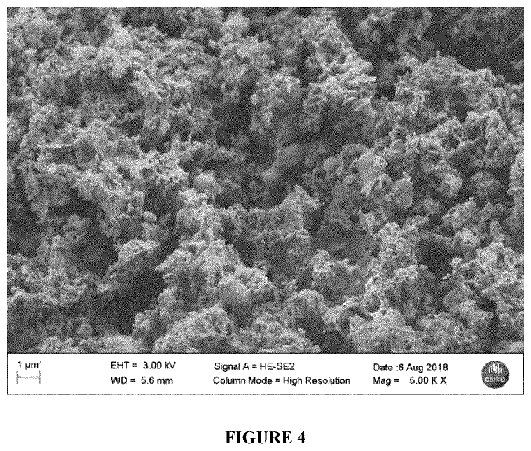

The discrete oxide (e.g. metal doped ceria) phases (e.g. particles or portions) may be interspersed within the metallic (e.g. silver) phase. Without wishing to be bound by theory, the junction at the interface between the metallic phase surface and the discrete oxide phases provides for a plurality of reactive sites throughout the sintered electrode material. The metal (e.g. silver) scaffold and discrete oxide (metal doped ceria) phases can promote the transport of electrons and/or mobile oxygen species (O²⁻), respectively, both to and from the reactive sites located throughout the sintered electrode material, for example when used as electrode compositions in SOECs or SOFCs. For example, owing to the unique microstructure of the sintered electrode, an ionic and electronic pathway is created to transfer electrons and mobile oxygen species (O²⁻) to and from the reactive sites located throughout the sintered electrode material. The location of one reactive site in the sintered electrode material is provided by way of example in the schematic in FIG. 3 when the sintered electrode composition are used as an oxygen electrode in a solid oxide electrolysis cell (SOEC). A scanning electron microscopy image of a sintered electrode composition is also shown in FIG. 4, showing a sintered silver phase comprising metal doped ceria.

In some embodiments, the sintered electrode material may comprise at least about 1, 2, 5, 10, 20, 50, 70, 100, 150, 200, 250, 300, 400, 500, 700 or 1000 discrete oxide phases per cm³ of metallic phase. The sintered electrode material may comprise less than about 1000, 700, 500, 400, 300, 250, 200, 150, 100, 70, 50, 20, 10, 5, 2 or 1 discrete oxide phases per cm³ of metallic phase. Combinations of any two or more of these upper and/or lower amounts are also possible, for example the sintered electrode material may comprise between about 10 to 100, 50 to 500 or 100 to 300 discrete oxide phases per cm³ of metallic phase. In some embodiments, the sintered electrode material may comprise at least about 1, 2, 5, 10, 20, 50, 70, 100, 150, 200, 250, 300, 400, 500, 700 or 1000 discrete metal doped ceria phases per cm³ of silver metal phase. The sintered electrode material may comprise less than about 1000, 700, 500, 400, 300, 250, 200, 150, 100, 70, 50, 20, 10, 5, 2 or 1 discrete metal doped ceria phases per cm³ of silver metal phase. Combinations of any two or more of these upper and/or lower amounts are also possible, for example the sintered electrode material may comprise between about 10 to 100, 50 to 500 or 100 to 300 discrete metal doped ceria phases per cm³ of silver metal phase. It will be appreciated that the interspersing of discrete oxide (e.g. metal doped ceria) phases within the metallic (e.g. silver) phase can be determined by a range of instruments and methods including spectroscopy and microscopy methods, for example scanning electron microscopy.

By sintering the electrode composition comprising hybrid electrode particles comprising metallic particles decorated with discrete oxide particles, as opposed to conventional mix and mill approach where individual metallic particles and oxide particles are present in a composition, an electrode material with improved dispersion of discrete oxide (e.g. metal doped ceria) particles or phases interspersed throughout the porous metallic (e.g. silver) scaffold is obtained and evidenced by the resulting microstructure. It has been surprisingly found that this sintering process provides an electrode material with enhanced electrical and ionic conductivity and catalytic activity for use as an electrode in solid oxide cells, e.g. SOECs or SOFCs. It will be appreciated that the hybrid electrode particles pre-sintering also provides a microstructure showing metallic (e.g. silver) particles decorated with oxide (e.g. ceria) particles, in contrast to a heterogeneous mixture of separate particles or metal particles coated with fine oxide particles such that the entire surface of the metal particles are covered with the fine oxide particles.

In some embodiments, the discrete oxide particles/phases interspersed within the metallic phase has a size (in nm) of at least about 1, 2, 5, 10, 25, 50, 75, 100, 125, 150, 175, 200, 400, 600, 800, or 1000. In some embodiments, the discrete oxide particles/phases interspersed within the metallic phase has a size (in nm) of less than about 1000, 800, 600, 400, 200, 175, 150, 125, 100, 75, 50, 25, 10, 5, 2 or 1. Combinations of any two or more of these upper and/or lower particle sizes are also possible, for example the discrete oxide particles/phases interspersed within the metallic phase has a size (in nm) of about 1 to 600, 2 to 400, 3 to 200, or 4 to 100. In some embodiments, the discrete metal doped ceria particles/phases interspersed within the silver metal phase has a size (in nm) of at least about 1, 2, 5, 10, 25, 50, 75, 100, 125, 150, 175, 200, 400, 600, 800, or 1000. In some embodiments, the discrete metal doped ceria particles/phases interspersed within the silver metal phase has a size (in nm) of less than about 1000, 800, 600, 400, 200, 175, 150, 125, 100, 75, 50, 25, 10, 5, 2 or 1. Combinations of any two or more of these upper and/or lower particle sizes are also possible, for example the discrete metal doped ceria particles/phases interspersed within the silver metal phase has a size (in nm) of about 1 to 600, 2 to 400, 3 to 200, or 4 to 100. The size of the oxide (e.g. metal doped ceria) phases/particles interspersed within the metallic (e.g. silver) phase can be measured by electron microscopy (e.g. TEM or SEM) or X-ray diffraction (e.g. Scherrer analysis of one or more diffraction peaks).

In some embodiments, the total amount of metallic phase in the sintered electrode material (in % w/w based on the total weight sintered electrode material) is at least 10, 15, 20, 30, 35, 40, 45, 50, 55, 60, 65, 70, 75 or 80. In some embodiments, the total amount of metallic phase in the sintered electrode material (in % w/w based on the total weight sintered electrode material) is less than about 80, 75, 70, 65, 60, 55, 50, 45, 40, 35, 30, 25, 20, 15 or 10. Combinations of any two or more of these upper and/or lower amounts are also possible, for example, the total amount of metallic phase in the sintered electrode material may be between about 20% w/w to 80% w/w, or about 55% to 75% w/w. In some embodiments, the total amount of metallic phase in the sintered electrode material (in % w/w based on the total weight sintered electrode material) is about 10, 15, 20, 30, 35, 40, 45, 50, 55, 60, 65, 70, 75, or 80. In some embodiments, the total amount of silver metal phase in the sintered electrode material (in % w/w based on the total weight sintered electrode material) is at least 10, 15, 20, 30, 35, 40, 45, 50, 55, 60, 65, 70, 75 or 80. In some embodiments, the total amount of silver metal phase in the sintered electrode material (in % w/w based on the total weight sintered electrode material) is less than about 80, 75, 70, 65, 60, 55, 50, 45, 40, 35, 30, 25, 20, 15 or 10. Combinations of any two or more of these upper and/or lower amounts are also possible, for example, the total amount of silver metal phase in the sintered electrode material may be between about 20% w/w to 80% w/w, or about 55% to 75% w/w. In some embodiments, the total amount of silver metal phase in the sintered electrode material (in % w/w based on the total weight sintered electrode material) is about 10, 15, 20, 30, 35, 40, 45, 50, 55, 60, 65, 70, 75, or 80.

In some embodiments, the total amount of oxide interspersed within the metallic phase (in % w/w based on the total weight of the sintered electrode material) is at least 20, 30, 35, 40, 45, 50, 55, 60, 65, 70, 75 or 80. In some embodiments, the total amount of oxide interspersed within the metallic phase (in % w/w based on the total weight of the sintered electrode material) is less than about 80, 75, 70, 65, 60, 55, 50, 45, 40, 35, 30, 25 or 20. Combinations of any two or more of these upper and/or lower amounts are also possible, for example, the total amount of oxide interspersed within the metallic phase may be between about 20% w/w to 50% w/w, or about 25% to 45% w/w. In some embodiments, the total amount of oxide interspersed within the metallic phase (in % w/w based on the total weight of the sintered electrode material) is about 20, 30, 35, 40, 45, 50, 55, 60, 65, 70, 75 or 80. In some embodiments, the total amount of metallic phase in the sintered electrode material is between about 20% w/w to 80% w/w, and the total amount of oxide in the sintered electrode material is between about 20% w/w to 60% w/w. In some embodiments, the total amount of metallic phase in the sintered electrode material is between about 55% w/w to 75% w/w, and the total amount of oxide in the sintered electrode material is between about 25% w/w to 45% w/w. In some embodiments, the total amount of ceria interspersed within the silver metal phase (in % w/w based on the total weight of the sintered electrode material) is at least 20, 30, 35, 40, 45, 50, 55, 60, 65, 70, 75 or 80. In some embodiments, the total amount of ceria interspersed within the silver metal phase (in % w/w based on the total weight of the sintered electrode material) is less than about 80, 75, 70, 65, 60, 55, 50, 45, 40, 35, 30, 25 or 20. Combinations of any two or more of these upper and/or lower amounts are also possible, for example, the total amount of ceria interspersed within the silver metal phase may be between about 20% w/w to 80% w/w, or about 25% to 45% w/w. In some embodiments, the total amount of ceria interspersed within the silver metal phase (in % w/w based on the total weight of the sintered electrode material) is about 20, 30, 35, 40, 45, 50, 55, 60, 65, 70, 75 or 80. In some embodiments, the total amount of silver metal phase in the sintered electrode material is between about 20% w/w to 80% w/w, and the total amount of ceria in the sintered electrode material is between about 20% w/w to 60% w/w. In some embodiments, the total amount of silver metal phase in the sintered electrode material is between about 55% w/w to 75% w/w, and the total amount of ceria in the sintered electrode material is between about 25% w/w to 45% w/w.

The thickness of the sintered electrode material may be selected to facilitate the transport of electrons and mobile ion species (e.g. O²⁻) both to and from reactive sites located throughout the electrode, the porosity, and reaction of reactant species occurring within the electrode.

The sintered electrode material may have a degree of porosity. In some embodiments, the sintered electrode material may have a porosity (in vol % based on the total volume of sintered electrode material) of at least 5, 10, 15, 20, 25, 30, 35, 40, 45, 50, 55, 60, 65 or 70. In some embodiments, the sintered electrode material may have a porosity (in vol % based on the total volume of sintered electrode material) of less than 70, 65, 60, 55, 50, 45, 40, 35, 30, 25, 20, 15, 10 or 5. Combinations of any two or more of these upper and/or lower porosity values are also possible, for example, the sintered electrode material may have a porosity of between about 10 to 60, about 20 to 50, about 25 to 45, or about 30 to 40 vol % based on the total volume of the sintered electrode material.

The porosity of the sintered electrode material may be determined by the density of the hybrid electrode particles in the electrode composition prior to sintering. The porosity can be determined by any suitable means, for example using a mercury porosity meter or by electron microscopy image analysis of the cross section of sintered electrode material using an image analysis tool such as ImageJ to view and measure the porosity by contrast.

The sintered electrode material may have any suitable thickness which will depend on the sintering of the electrode composition comprising the hybrid electrode particles. The thickness of the sintered electrode material may be between any one of the following ranges (in μm): about 10 and 2000, about 15 and 1000, about 20 and 500, about 25 and 400, about 30 and 300, about 40 and 200, or about 50 and 150. The thickness of the sintered electrode material be at least about 10 μm, 30 μm, 50 μm, 70 μm, or 90 μm 150 μm, 200 μm, 300 μm, 500 μm, 750 μm, or 1000 μm. The thickness of the sintered electrode material may be less than about 2000 μm, 1500 μm, 1000 μm, 800 μm, 600 μm, 400 μm, or 200 μm. The thickness of the sintered electrode material may be between any one of the following ranges (in μm): about 1 and 100, about 5 and 80, about 5 to 70, about 10 to 50 or about 15 to 40. The thickness of the sintered electrode material be at least about 1 μm, 5 μm, 10 μm, 20 μm, 50 μm, 70 μm 80 μm, or 100 μm. The thickness of the sintered electrode material may be less than about 100 μm, 80 μm, 70 μm, 50 μm, 20 μm, 10 μm, 5 μm, or 1 μm.

### Coating Formulations

The electrode composition may be a coating formulation, such as a liquid formulation, for which the following examples and embodiments may apply. The electrode composition, or sintered electrode material thereof, can be provided as a coating formulation for commercial and industrial application. The coating formulation can be prepared to apply the electrode composition, or sintered electrode material thereof, on the surface of a substrate as described in any one of the examples or embodiments. A coating formulation can be prepared by dissolving or dispersing the electrode composition according to any embodiments or examples thereof as described herein or sintered electrode material thereof, in an appropriate solvent and then mixing them together optionally with one or more additives (e.g. a binder) or dissolving the compositions into a suitable solvent under suitable processing conditions. For example, the coating formulation may be a wet coating formulation comprising the electrode composition or sintered electrode material thereof, a solvent, and optionally a binder. One example method is to first dissolve the binder(s) in the solvent(s) of the formulation, which may be done with the accompanying use of heat and/or stirring. The electrode composition or sintered electrode material thereof may then be added, desirably at a gradual rate of addition to avoid lumping. Heat and/or stirring may again be applied during the addition of the electrode composition or sintered electrode material thereof.

The wet coating formulation may be applied to a substrate (e.g. a solid electrolyte) in different physical forms such as a solution, dispersion, suspension, mixture, aerosol, emulsion, paste or combination thereof, solutions or dispersions or emulsions are preferred.

In some embodiments, the wet coating formulation may be a dip coating formulation, a printable ink formulation or a brush printing formulation. The wet coating formulation may be a dip coating formulation. The wet coating formulation may be a printable ink formulation. The wet coating formulation may be a brush printing formulation. Any solvent capable of dissolving/suspending the electrode composition or sintered electrode material thereof and binder in the coating formulation may be used. The solvent may be a single solvent or a mixture of solvents that dissolve the binder and that can evaporate following dip coating while being dried under mild drying conditions such as, for example, about 50° C. to about 250° C. The solvent may be an alcohol, ester, terpene, ketone, aliphatic, aromatic, ethers or water, including mixtures thereof. In one embodiment, the solvent may be an alcohol. Suitable alcohol solvents include monohydric alcohols, diol alcohols such as glycols, ether alcohols, and terpene alcohols. Examples include methanol, ethanol, n-propyl alcohol, isopropyl alcohol, n-butyl alcohol, isobutyl alcohol, hexanol, heptanol, cyclohexanol, butyl glycol, diols such as ethylene glycol, propylene glycol, diethylene glycol, triethylene glycol, ether alcohols such as butoxyethanol, propoxypropanol and butyldiglycol, and terpene alcohols such as, terpineol (α-terpineol), β-terpineol, geraniol, cineol, cedral, linalool, 4-terpineol, lavandulol, citronellol, or nerol. In one example, ethanol may be a preferred solvent. In another example, mixtures of one or more solvents may be used, e.g. a mixture of ethanol and α-terpineol.

The coating formulation may comprise solvent (% w/w)) in an amount of at least about 1, 2, 5, 10, 15, 20, 25, 30, 35, 40, 45 or 50 based on the total weight of the formulation. The coating formulation may comprise solvent (% w/w)) in an amount of less than about 50, 45, 40, 35, 30, 25, 20, 15, 10, 5, 2 or 1 based on the total weight of the formulation. Combinations of these amounts are also possible, for example between about 25% w/w to about 45% w/w. In some embodiments, the coating formulation comprises a monohydric alcohol solvent (e.g. ethanol) in an amount of between about 20% w/w to 40% w/w and a terpene alcohol solvent (e.g. α-terpineol) in an amount of between about 1% w/w to about 10% w/w, based on the total weight of the coating formulation.

Any suitable binder may be used to prepare the coating formulations. In one embodiment, the binder may be polyvinyl butyral, polyvinyl alcohol, polyacrylate esters, polymethyl methacrylate or ethyl cellulose. The coating formulation may comprise a binder (% w/w) in an amount of at least about 1, 2, 3, 4, 5, 6, 8, 10, 15 or 20 based on the total weight of the formulation. The coating formulation may comprise a binder (% w/w) in an amount of less than about 20, 15, 10, 8, 6, 5, 4, 3, 2 or 1 based on the total weight of the formulation. Combinations of these amounts are also possible for example, between about 1% w/w to about 5% w/w.

In some embodiments or examples, the thickness of the coating formulation may be in a range between about 1 to about 100 μm. The thickness (in μm) may be less than about 100, 80, 60, 40, 20, 15, 10, 8, 6, 4, 2 or 1. The thickness (in μm) may be at least about 1, 2, 4, 6, 8, 10, 15, 20, 30, 40, 50, 60, 70, 80, 90 or 100. The thickness (μm) of the coating formulation may be in a range provided by any two of these upper and/or lower values. For example, the thickness of the coating formulation may be about 50 μm. The thickness of the coating formulation may be selected to facilitate the transport of electrons and mobile ion species (e.g. O²⁻) both to and from reactive sites located throughout the electrode, the porosity, and reaction of reactant species occurring within the electrode.

The coating formulation may have a degree of porosity. In some embodiments, the coating formulation may have a porosity (in vol % based on the total volume of coating formulation) of at least 5, 10, 15, 20, 25, 30, 35, 40, 45, 50, 55, 60, 65 or 70. In some embodiments, the coating formulation may have a porosity (in vol % based on the total volume of sintered electrode material) of less than 70, 65, 60, 55, 50, 45, 40, 35, 30, 25, 20, 15, 10 or 5. Combinations of any two or more of these upper and/or lower porosity values are also possible, for example, the coating formulation may have a porosity of between about 10 to 60, about 20 to 50, about 25 to 45, or about 30 to 40 vol % based on the total volume of the sintered electrode material.

The porosity of the coating formulation may be determined by the density of the hybrid electrode particles in the electrode composition prior to sintering. The porosity can be determined by any suitable means, for example using a mercury porosity meter or by electron microscopy image analysis of the cross section of the coating formulation using an image analysis tool such as ImageJ to view and measure the porosity by contrast.

### Processes for Preparing Hybrid Electrode Particles

The present inventors have also identified a modified sol-gel process that can be used to prepare the hybrid electrode particles. By controlling the reaction conditions and reagents of the modified sol-gel process, the stoichiometry of the silver and ceria of the hybrid electrode particles can be finely tuned resulting in electrode compositions that comprise the same having improved electrical, ionic and/or catalytic properties.

The hybrid electrode particles can be prepared via a modified sol-gel process. As used herein, the term “modified sol-gel process” refers to the synthesis of solid materials from solution-state precursors, and involves the conversion of monomers into a colloidal solution (i.e. sol) that acts as the precursor for a network (or gel) of discrete particles, which is then heated to obtain the solid material. An example of such a process is the Pechini method.

The modified sol-gel process for preparing hybrid electrode particles, wherein each hybrid electrode particle comprises at least one metallic phase and one oxide phase, wherein the metallic phase comprises a plurality of metallic particles and the oxide phase comprises a plurality of ion or mixed ion conducting oxide particles on the surface of the metallic particle(s), wherein the plurality of ion or mixed ion conducting oxide particles are decorated on the surface of the metallic particle(s), and wherein the particle size (in nm) of the ion or mixed ion conducting oxide particles on the surface of the metallic particle is between about 1 to 100, wherein the process comprises:
a) preparing a gel from an aqueous solution comprising a metallic species, an ion or mixed ion conducting oxide species, a plasticizer, and a chelating agent; and
b) heating the gel to obtain a powder composition comprising the hybrid electrode particles.

In another embodiment, the modified sol-gel process for preparing hybrid electrode particles comprises:
a) preparing a gel from an aqueous solution comprising a silver metal species, a cerium metal species, a metal dopant species, a plasticizer, and a chelating agent; and
b) heating the gel to obtain a powder composition comprising the hybrid electrode particles.

In another embodiment the modified sol-gel process for preparing hybrid electrode particles, wherein the process comprises:
a) preparing a gel from an aqueous solution comprising a bimetallic metal species, a cerium metal species, a metal dopant species, a plasticizer, and a chelating agent; and
b) heating the gel to obtain a powder composition comprising the hybrid electrode particles.

In another embodiment the modified sol-gel process for preparing hybrid electrode particles, wherein the process comprises:
a) preparing a gel from an aqueous solution comprising a bimetallic metal species, a metal doped ferrite, a plasticizer, and a chelating agent; and
b) heating the gel to obtain a powder composition comprising the hybrid electrode particles.

### Metal Species

One or more of the metal species (e.g. cerium, silver, etc.) and metal dopant species, can be provided as salts or hydrates thereof. In one embodiment, the metal species and metal dopant species are cationic (i.e. ionic salts or hydrates thereof). The metal species and metal dopant species should be soluble or miscible in the aqueous solution either alone or in the presence of the chelating agent. Accordingly, typical salts include hydroxides, alkoxides, acetates, chlorides, citrates, and nitrates, with nitrates being preferred.

The metal (e.g. silver) species may be provided as any suitable salt or hydrate thereof independently selected from hydroxides, chlorides, alkoxides, acetates, citrates, nitrates, and oxide salts. In some embodiments, the silver metal species may be provided as silver nitrate (AgNO₃), silver chloride (AgCl), silver hydroxide (AgOH), or silver oxide (Ag₂O), or hydrate thereof.

The metal (e.g. cerium) species may be provided as any suitable salt or hydrate thereof independently selected from hydroxides, chlorides, alkoxides, acetates, citrates, nitrates, and oxide salts. In some embodiments, the cerium metal species may be provided as cerium nitrate (Ce(NO₃)₃), cerium chloride (CeCl₃), cerium hydroxide (Ce(OH)₃), or cerium oxide (Ce₂O₃) or hydrate thereof. Examples of suitable hydrates include the hexahydrate salts, for example cerium nitrate hexahydrate (Ce(NO₃)₃·6H₂O).

In one embodiment, the present inventors have unexpectedly found that the combination of silver nitrate (AgNO₃) and cerium nitrate (Ce(NO₃)₃) can result in a hybrid electrode particle with improved conductivity and catalytic activity. It will be appreciated that the improved conductivity and catalytic activity may be due to the resulting microstructure showing silver particles decorated with nanocrystalline ceria particles. However, other salt forms, including cerium chloride (CeCl₃) have also resulted in hybrid electrode particles having similar performance and/or microstructure.

In other embodiment, the present inventors have unexpectedly found that the combination of silver nitrate (AgNO₃) and iron nitrate nonahydrate as a metal species and doped cerium nitrate (Ce(NO₃)₃) as a mixed oxide phase can result in a hybrid electrode particle with improved conductivity and catalytic activity. It will be appreciated that the improved conductivity and catalytic activity may be due to the resulting microstructure showing bimetallic metal particles decorated with nanocrystalline ceria particles.

In other embodiment, the present inventors have unexpectedly found that the combination of silver nitrate (AgNO₃) as a metal species and lanthanum nitrate hexahydrate, strontium nitrate, cobalt nitrate hexahydrate and iron nitrate nonahydrate as a mixed oxide phase can result in a hybrid electrode particle with improved conductivity and catalytic activity. It will be appreciated that the improved conductivity and catalytic activity may be due to the resulting microstructure showing bimetallic metal particles decorated with lanthanum strontium doped ferrite phases.

The metal dopant species may be provided as any suitable salt or hydrate thereof. In some embodiments, the metal dopant species may be selected from a rare-earth metal salt or an alkaline earth metal salt, or hydrate thereof. In some embodiments, the metal dopant species may be provided by one or more metal salts or hydrates thereof selected from samarium (Sm), gadolinium (Gd), lanthanum (La), zirconium (Zr), yttrium (Y), ytterbium (Yb), erbium (Er), praseodymium (Pr) or neodymium (Nd) salts or hydrates thereof. The salts may be any one or more of nitrates, chlorides, hydroxides or oxides. In some embodiments, the metal dopant species may be provided by a nitrate salt of one or more of samarium (Sm), gadolinium (Gd), lanthanum (La), zirconium (Zr), yttrium (Y), ytterbium (Yb), erbium (Er), praseodymium (Pr) or neodymium (Nd) salts, or hydrates thereof. In some embodiments, the metal dopant species may be provided by a nitrate salt of gadolinium (Gd) samarium (Sm) and yttrium (Y), or hydrates thereof.

In one embodiment, the metal dopant species may be provided by gadolinium nitrate (Gd(NO₃)₃) or a hydrate thereof, for example gadolinium nitrate hexahydrate (Gd(NO₃)₃·6H₂O). The present inventors have identified that good amounts of metal doping within the ceria particles can occur using gadolinium nitrate owing to the similar ionic size of gadolinium compared with cerium allowing for efficient integration of gadolinium into the ceria network.

In some embodiments, the oxide species and metal dopant species may be each provided in the aqueous solution at a concentration of at least about 0.01, 0.02, 0.03, 0.04, 0.05, 0.06, 0.07, 0.08, 0.09, 0.1, 0.2, 0.3, 0.4, 0.5 or 1.0 M. In some embodiments, the oxide species and metal dopant species may be each provided in the aqueous solution at a concentration of less than about 1.0, 0.5, 0.4, 0.3, 0.2 0.1, 0.09, 0.08, 0.07, 0.06, 0.05, 0.04, 0.03, 0.02, or 0.01 M. Combinations of any two or more of these upper and/or lower concentrations are also possible, for example, the oxide species and metal dopant species may be each provided in the aqueous solution at a concentration of between about 0.01 to 0.05, or 0.01 to 0.1 M. In some embodiments, the oxide species and metal dopant species may be each provided in the aqueous solution at a concentration of about 0.01, 0.02, 0.03, 0.04, 0.05, 0.06, 0.07, 0.08, 0.09, 0.1, 0.2, 0.3, 0.4, 0.5 or 1.0 M.

In some embodiments, the cerium metal species and metal dopant species may be each provided in the aqueous solution at a concentration of at least about 0.01, 0.02, 0.03, 0.04, 0.05, 0.06, 0.07, 0.08, 0.09, 0.1, 0.2, 0.3, 0.4, 0.5 or 1.0 M. In some embodiments, the cerium metal species and metal dopant species may be each provided in the aqueous solution at a concentration of less than about 1.0, 0.5, 0.4, 0.3, 0.2 0.1, 0.09, 0.08, 0.07, 0.06, 0.05, 0.04, 0.03, 0.02, or 0.01 M. Combinations of any two or more of these upper and/or lower concentrations are also possible, for example, the cerium metal species and metal dopant species may be each provided in the aqueous solution at a concentration of between about 0.01 to 0.05, or 0.01 to 0.1 M. In some embodiments, the cerium metal species and metal dopant species may be each provided in the aqueous solution at a concentration of about 0.01, 0.02, 0.03, 0.04, 0.05, 0.06, 0.07, 0.08, 0.09, 0.1, 0.2, 0.3, 0.4, 0.5 or 1.0 M.

In some embodiments, the metal species may be provided in the aqueous solution at a concentration of at least about 0.01, 0.02, 0.03, 0.04, 0.05, 0.06, 0.07, 0.08, 0.09, 0.1, 0.2, 0.3, 0.4, 0.5 or 1.0 M. The concentration may be selected based on a desired w/w % of metal in the final hybrid electrode particles. In some embodiments, the metal species may be provided in the aqueous solution at a concentration of less than about 1.0, 0.5, 0.4, 0.3, 0.2 0.1, 0.09, 0.08, 0.07, 0.06, 0.05, 0.04, 0.03, 0.02, or 0.01 M. Combinations of any two or more of these upper and/or lower concentrations are also possible, for example, the metal species may be provided in the aqueous solution at a concentration of between about 0.01 to 0.1 M.

In some embodiments, the silver metal species may be provided in the aqueous solution at a concentration of at least about 0.01, 0.02, 0.03, 0.04, 0.05, 0.06, 0.07, 0.08, 0.09, 0.1, 0.2, 0.3, 0.4, 0.5 or 1.0 M. The concentration may be selected based on a desired w/w % of silver in the final hybrid electrode particles. In some embodiments, the silver metal species may be provided in the aqueous solution at a concentration of less than about 1.0, 0.5, 0.4, 0.3, 0.2 0.1, 0.09, 0.08, 0.07, 0.06, 0.05, 0.04, 0.03, 0.02, or 0.01 M. Combinations of any two or more of these upper and/or lower concentrations are also possible, for example, the silver metal species may be provided in the aqueous solution at a concentration of between about 0.01 to 0.1 M.

In some embodiments, the molar ratio of metal species to oxide species may be at least about 1:10, 1:5, 1:4, 1:3, 1:2, 1:1, 2:1, 3:1, 4:1, 5:1, or 10:1. In some embodiments, the molar ratio of metal species to oxide species may be less than about 10:1, 5:1, 4:1, 3:1, 2:1, 1:1, 1:2, 1:3, 1:4, 1:5, or 1:10. Combinations of any two or more of these upper and/or lower ratios are also possible, for example, the molar ratio of metal species to oxide species may be between about 1:5 to about 5:1, or about 1:2 to 1:1.

In some embodiments, the molar ratio of silver metal species to cerium metal species may be at least about 1:10, 1:5, 1:4, 1:3, 1:2, 1:1, 2:1, 3:1, 4:1, 5:1, or 10:1. In some embodiments, the molar ratio of silver metal species to cerium metal species may be less than about 10:1, 5:1, 4:1, 3:1, 2:1, 1:1, 1:2, 1:3, 1:4, 1:5, or 1:10. Combinations of any two or more of these upper and/or lower ratios are also possible, for example, the molar ratio of silver metal species to cerium metal species may be between about 1:5 to about 5:1, or about 1:2 to 1:1.

The present inventors have found that the ratio of metal species to oxide species is important to control the amount ion or mixed ion conducting oxide present in the hybrid electrode particles. In particular, according to at least some embodiments or examples, it is advantageous to retain at least part of the surface of the metal particles free from oxide particles to allow for interaction with the metal surface on neighboring hybrid electrode particle(s) thus providing electronic conduction other portion providing numerous oxide particles. The present inventors have unexpectedly identified that a ratio of metal to oxide species of between about 2:1 to 1:1 can provide both enhanced levels of oxide decoration whilst retaining sufficient areas of the metal particle surface free for interaction with the metal surface on neighboring particles.

The present inventors have found that the ratio of silver to metal species is important to control the amount ceria present in hybrid electrode particles. In particular, according to at least some embodiments or examples, it is advantageous to retain at least part of the surface of the silver particles free from ceria to allow for interaction with the silver surface on neighboring hybrid electrode particle(s) thus providing electronic conduction other portion providing numerous ceria particles. The present inventors have unexpectedly identified that a ratio of silver to metal species of between about 2:1 to 1:1 can provide both enhanced levels of ceria decoration whilst retaining sufficient areas of the silver particle surface free for interaction with the silver surface on neighboring particles. For example, electrodes prepared with 70 wt. % silver and 30 wt. % mixed ion conducting phases showed higher performance as shown in at least one of the examples provided herein.

In some embodiments, the molar ratio of metal dopant species to oxide species is at least about 1:100, 1:80, 1:50, 1:20, 1:10, 1:5 or 1:1. In some embodiments, the molar ratio of metal dopant species to oxide species is less than about 1:1. 1:5. 1:10, 1:20, 1:50, 1:80 or 1:100. Combinations of any two or more of these upper and/or lower ratios are also possible, for example, the molar ratio of metal dopant species to oxide species may be between about 1:50 to 1:1. In some embodiments, the molar ratio of metal dopant species to oxide species is about 1:100, 1:80, 1:50, 1:20, 1:10, 1:5 or 1:1.

In some embodiments, the molar ratio of metal dopant species to cerium metal species is at least about 1:100, 1:80, 1:50, 1:20, 1:10, 1:5 or 1:1. In some embodiments, the molar ratio of metal dopant species to cerium metal species is less than about 1:1. 1:5. 1:10, 1:20, 1:50, 1:80 or 1:100. Combinations of any two or more of these upper and/or lower ratios are also possible, for example, the molar ratio of metal dopant species to cerium metal species may be between about 1:50 to 1:1. In some embodiments, the molar ratio of metal dopant species to cerium metal species is about 1:100, 1:80, 1:50, 1:20, 1:10, 1:5 or 1:1.

### Chelating Agent

The chelating agent may be any suitable compound that can both coordinate to the silver metal species, cerium metal species and/or the metal dopant species, while providing one or more functional groups that can cross-link with the plasticizer (e.g. via esterification) to create the gel comprising the silver metal species, cerium metal species and metal dopant species. In one embodiment, the same chelating agent is used to separately chelate each of the silver metal species, cerium metal species and metal dopant species. Alternatively, different chelating agents can be used which may be selected based on their chelating affinity to one or more metal species.

In some embodiments, the chelating agent is selected from carboxylic acids, amines, amino acids, aminopolycarboxylic acids, diesters, β-diketones, β-ketoesters, and any combinations thereof. Suitable carboxylic acids include di-, tri-, or tetra-carboxylic acids (e.g. compounds comprising 2, 3 or 4 carboxylic acid groups), including for example citric acid, lactic acid, glycolic acid, malonic acid, tartaric acid, succinic acid, glutaric acid, or malic acid, and any combinations thereof. Suitable amino acids include glycine, methionine, lysine or glycine, and any combinations thereof. Suitable aminopolycarboxylic acids include ethylenediaminetetraacetic acid (EDTA), iminodiacetic acid (IDA), nitrilotriacetic acid (NTA), diethylenetriaminepentaacetic acid (DTPA), or 1,4,7,10-Tetraazacyclododecane-1,4,7,10-tetraacetic acid (DOTA), and any combinations thereof. In one embodiment, the chelating agent is selected from citric acid, glycine or EDTA, and any combinations thereof. In particular, citric acid and EDTA have been found to be particularly effective chelating agents to form the hybrid electrode particles.

In some embodiments, the molar ratio of chelating agent to metal species present in the aqueous solution (e.g. the silver metal species, cerium metal species and metal dopant species) is at least about 1:5, 1:4, 1:3, 1:2, 1:1, 2:1, 3:1, 4:1 or 5:1. In some embodiments, the molar ratio of chelating agent to metal species in the aqueous solution is less than about 5:1, 4:1, 3:1, 2:1, 1:1, 1:2, 1:3, 1:4 or 1:5. Combinations of any two or more of these upper and/or lower ratios are also possible, for example, the molar ratio of chelating agent to metal species present in the aqueous solution may be between about 1:5 to about 5:1, about 1:2 to about 2:1. The present inventors have found that a ratio of chelating agent to metal species present in the aqueous solution of about 1:1 to 1:5, for example 1:2, can provide further advantages, such as forming a stable aqueous chelated solution with the metal species which may result in a stable solution with minimal or no precipitation observed.

### Plasticizer

To form the gel at step a), the chelating agent chelates to the metal species and subsequently cross-linked with the plasticizer to form a covalent network in the form of a gel, for example via esterification. One or more advantages are associated with forming a gel as described herein, including stabilizing and immobilizing the metal species to prevent segregation which allows for the synthesis of homogenous doped metal oxides (e.g. gadolinium doped ceria). The plasticizer can therefore be any suitable compound capable of crosslinking the chelates in the aqueous solution. The crosslinking may occur via any suitable reaction between functional groups on the chelating agent and plasticizer, for example via esterification (e.g. polyalcohol and carboxylic acid) or amidification (amine and carboxylic acid).

In one embodiment, the plasticizer may be a polyol (i.e. polyalcohol). The plasticizer may be a glycol. Suitable glycols include ethylene glycol, diethylene glycol, propylene glycol, butylene glycol and triethylene glycol, and combinations thereof. In one embodiment, the plasticizer is selected from ethylene glycol, diethylene glycol and triethylene glycol, and mixtures thereof. According to some embodiments or examples, the inventors have found that glycol plasticizers readily form a gel with carboxylic acid chelating agents (e.g. citric acid) via esterification to form a stable gel comprising the one or more metal species described herein, highlighted by way of example below (image sourced from Dimesso L. (2018) Pechini Processes: An Alternate Approach of the Sol-Gel Method, Preparation, Properties, and Applications. In: Klein L., Aparicio M., Jitianu A. (eds) Handbook of Sol-Gel Science and Technology. Springer, Cham. https://doi.org/10.1007/978-3-319-32101-1_123):

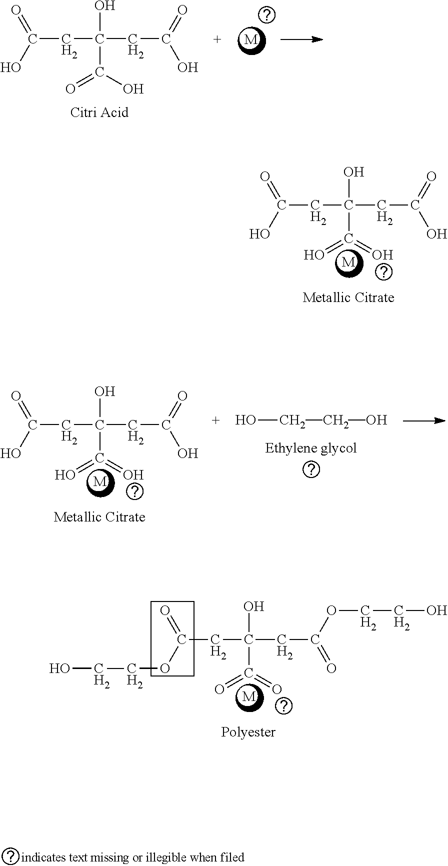

In some embodiments, the molar ratio of plasticizer to metal species present in the aqueous solution (e.g. the silver metal species, cerium metal species and metal dopant species) is at least about 1:1, 2:1, 3:1, 4:1, 5:1, 6:1, 7:1, or 8:1. In some embodiments, the molar ratio of plasticizer to metal species in the aqueous solution is less than about 8:1, 7:1, 6:1, 5:1, 4:1, 3:1, 2:1, 1:1, 1:2, 1:3, 1:4 or 1:5. Combinations of any two or more of these upper and/or lower ratios are also possible, for example, the molar ratio of plasticizer to metal species present in the aqueous solution may be between about 1:1 to about 6:1, about 1:1 to about 4:1. In some embodiments, the molar ratio of plasticizer to metal species present in the aqueous solution is about 1:1, 2:1, 3:1, 4:1, 5:1, 6:1, 7:1, or 8:1. The present inventors have found that a ratio of plasticizer to metal species present in the aqueous solution of about 1:1 to 5:1, for example about 2:1 to 4:1 provides a plasticizer rich aqueous solution that readily cross-links with the chelating agent to from a stable gel comprising the metal species.

In some embodiments, the molar ratio of plasticizer to chelating agent in the aqueous solution is at least about 1:1, 2:1, 3:1, 4:1 or 5:1, for example at least about 2:1 (e.g. 2 plasticizer compounds per 1 chelate).

### Aqueous Solution and Gel Comprising Metal Species

Depending on the degree of cross-linking between the plasticizer and chelating agent present in the aqueous solution, the aqueous solution at step a) may be viscous but flowable prior to forming the gel. The aqueous solution used to prepare the gel at step a) may be prepared using any suitable aqueous media, for example water (e.g. deionized water).

The pH of the aqueous solution may be adjusted to promote chelation of one or more metal species, control the polymerization of the chelating agent and the plasticizer and/or to prevent precipitation of one or more metal species. The pH may be controlled by adding any suitable base or acid. For example, to increase the pH of the aqueous solution to a more basic (i.e. less acidic) pH, a suitable base may be added to the aqueous solution. Suitable bases may include urea, ammonium or ammonium hydroxide. To decrease the pH of the aqueous solution to a more acidic (i.e. less basic) pH, a suitable acid may be added to the aqueous solution. Suitable acids may include nitric acid.

The pH of the aqueous solution may be adjusted by adding a suitable acid or base to achieve a pH of at least about pH 3, 3.5, 4, 4.5, 5, 5.5, 6 or 7. The pH of the aqueous solution may be adjusted by adding a suitable acid or base to achieve a pH of less than about pH 7, 6.5, 6, 5.5, 5, 4.5, 4, 3.5 or 3. Combinations of any two or more of these upper and/or lower pH values are also possible, for example, between about pH 3 to about pH 7.

The gel may form spontaneously from the aqueous solution comprising a silver metal species, a cerium metal species, a metal dopant species, a plasticizer, and a chelating agent. For example, polysterification of excess carboxylic acid groups of the chelating agent with a polyol plasticizer may spontaneously occur in the aqueous solution.

In some embodiments the aqueous solution at step a) may be aged for a period of time and suitable temperature to promote the cross-linking between the plasticizer and chelating agent e.g. to aid in polysterification, to form the gel. In some embodiments, the aqueous solution is aged for a period of time of at least about 6, 8, 10, 12, 18, 24, 36 or 48 hours to form the gel. The aqueous solution may be aged for a period of time of less than about 48, 36, 24, 18, 12, 10, 8 or 6 hours to form the gel. Combinations of any two or more of these upper and/or lower aging times are also possible, for example, the aqueous solution is aged for a period of time of between about 12 hours to 36 hours prior to form the gel providing uniform structure and phase consistency. In some embodiments, the aqueous solution is aged for a period of time of about 6, 8, 10, 12, 18, 24, 36 or 48 hours to form the gel. In one embodiment, the aqueous solution may be aged for a period of time of about 24 to 36 hours prior to the heating at step b).

In some embodiments, the aqueous solution may be aged at a temperature of at least about 60, 65, 70, 75, 80, 85, 90, or 95° C. to form the gel. In some embodiments, the aqueous solution may be aged at a temperature of less than about 95, 90, 85, 80, 75, 70, 65, or 60° C. to form the gel. Combinations of any two or more of these upper and/or lower aging temperatures are also possible.

It will be appreciated that combinations of any two or more of the above aging temperatures times are also possible, for example the aqueous solution may be aged for a period of time of between about 12 hours to 36 hours and at a temperature of between about 65° C. to 90° C. to form the gel.

The aging of the aqueous solution at step a) may be a two-step aging process. In one embodiment, the aqueous solution is aged at a first temperature and for a period of time effective to promote the cross-linking between the plasticizer and chelating agent (e.g. to aid in polysterification and/or to remove any residual aqueous solution), and then cooled to a second temperature and aged for a period of time effective to form the gel. For example, the process may comprise (i) aging the aqueous solution at a first temperature and for a period of time effective to promote the cross-linking between the plasticizer and chelating agent (e.g. to aid in polysterification and/or to remove any residual aqueous solution), and then (ii) cooled to a second temperature and aged for a period of time at the cooled second temperature effective to form the gel.

For step (i), the aqueous solution may be aged at a temperature of at least about 60, 65, 70, 75, 80, 85, 90, or 95° C. The temperature for the aging at step (i) may be less than about 95, 90, 85, 80, 75, 70, 65, or 60° C. to form the gel. Combinations of any two or more of these upper and/or lower aging temperatures are also possible, for example, the between about 65° C. to 90° C., or about 70° C. to 85° C. For step (i), the aqueous solution may be aged for a period of time of at least about 6, 8, 10, 12, 18, 24, 36 or 48 hours. The aging at step (i) may be for a period of time of less than about 48, 36, 24, 18, 12, 10, 8 or 6 hours. Combinations of any two or more of these upper and/or lower aging times are also possible, for example between about 12 hours to 36 hours, e.g. 24 hours. It will be appreciated that combinations of any two or more of the above aging temperatures times are also possible, for example at step (i) the aqueous solution may be aged for a period of time of between about 12 hours to 36 hours and at a temperature of between about 65° C. to 95° C.

For step (ii), the aqueous solution may be cooled to a temperature lower than the temperature of the aging at step (i). For example, at step (ii) the aqueous solution may be cooled to a temperature at least about 5, 10, 15, 20, 25, 30, 35, 40, 50, or 60° C. At step (ii), the aqueous solution may be cooled to a temperature of less than about 60, 50, 40, 35, 30, 25, 20, 15, 10 or 5° C. Combinations of any two or more of these upper and/or lower cooled aging temperatures are also possible, for example, the between about 5° C. to 40° C., or about 10° C. to 30° C., e.g. room temperature. For step (ii), the aqueous solution may be aged at the cooled temperature for a period of time of at least about 2, 4, 6, 8, 10, 12, 18, 24, 36 or 48 hours. The aging at step (i) may be for a period of time of less than about 48, 36, 24, 18, 12, 10, 8, 6 or 4 hours. Combinations of any two or more of these upper and/or lower aging times are also possible, for example between about 2 hours to 12 hours, or about 4 hours to 8 hours. It will be appreciated that combinations of any two or more of the above aging temperatures times are also possible, for example at step (ii) the aqueous solution may be aged for a period of time of between about 4 hours to 8 hours and at a temperature of between about 10° C. to 30° C.

In some embodiments, after step a) but prior to step b), the gel may be also be aged for a period of time and suitable temperature prior to the hearing at step b) to further promote the cross-linking between the plasticizer and chelating agent e.g. to aid in polysterification, and/or to remove the any residual aqueous solution. It will be appreciated that this aging step is different to the heating of the gel at step b) (e.g. pyrolysing) to obtain a powder composition comprising the hybrid electrode particles. One or more advantages of aging the gel may include further stabilising and/or promoting the cross-linking between the plasticizer and chelating agent, providing a uniform microstructure and/or phase consistency.

In one embodiment, the aging of the gel prior to step b) is performed at a lower temperature that the heating of the gel at step b) to obtain the powder composition comprising the hybrid electrode particles, i.e. the electrode composition as described herein. In some embodiments, the gel formed in step a) is aged for a period of time of at least about 6, 8, 10, 12, 18, 24, 36 or 48 hours prior to the heating at step b). The gel formed in step a) may be aged for a period of time of less than about 48, 36, 24, 18, 12, 10, 8 or 6 hours prior to the heating at step b). Combinations of any two or more of these upper and/or lower aging times are also possible, for example, the gel formed in step a) is aged for a period of time of between about 12 hours to 48 hours or between about 24 hours to 48 hours prior to the heating at step b). In some embodiments, the gel formed in step a) is aged for a period of time of about 6, 8, 10, 12, 18, 24, 36 or 48 hours prior to the heating at step b). In one embodiment, the gel formed in step a) may be aged for a period of time of between about 24 hours to 48 hours prior to the heating at step b).

In some embodiments, the gel formed in step a) may be aged at a temperature of at least about 60, 65, 70, 75, 80, 85, 90, or 95° C. prior to the heating at step b). In some embodiments, the gel formed in step a) may be aged at a temperature of less than about 95, 90, 85, 80, 75, 70, 65, or 60° C. prior to the heating at step b). Combinations of any two or more of these upper and/or lower aging temperatures are also possible, for example, the gel formed in step a) is aged for at a temperature of between about 65° C. to 90° C., or about 70° C. to 85° C. prior to the heating at step b). In some embodiments, the gel formed in step a) may be aged at a temperature of about 60, 65, 70, 75, 80, 85, 90, or 95° C. prior to the heating at step b). It will be appreciated that combinations of any two or more of the above aging temperatures times are also possible, for example the gel formed in step a) may be aged for a period of time of between about 12 hours to 36 hours and at a temperature of between about 60° C. to 90° C. prior to the heating at step b).

The aging described above may be performed using any conventional oven such as a lab drying oven or convection oven. In one embodiment, the aging is performed by drying (e.g. in a lab drying oven or convention oven).

In one embodiment, step a) comprises preparing an aqueous solution comprising the oxide species and the metal dopant species, followed by addition of the chelating agent, plasticizer, and then metal species to the aqueous solution.

In one embodiment, step a) comprises preparing an aqueous solution comprising the cerium metal species and the metal dopant species, followed by addition of the chelating agent, plasticizer, and then silver metal species to the aqueous solution.

In a further embodiment, the aqueous solution comprising the oxide species, metal dopant species, chelating agent and plasticizer is aged prior to the addition of the metal species. In a further embodiment, the aqueous solution comprising the cerium metal species, metal dopant species, chelating agent and plasticizer is aged prior to the addition of the silver metal species. This aging step can be performed at any temperature and for a period of time as described above in relation to the gel, for example the aqueous solution is aged at a temperature of between about 65° C. to 90° C., or about 70° C. to 85° C. for 12 hours to 36 hours prior to addition of the silver metal species. This forms an intermediate gel/viscous aqueous solution prior to addition of the metal species (e.g. silver). Alternatively, the metal species is added to the aqueous solution prior to any aging step.

The metal species may be added to the aqueous solution comprising the oxide species, metal dopant species, chelating agent and plasticizer as an aqueous solution. The silver metal species may be added to the aqueous solution comprising the cerium metal species, metal dopant species, chelating agent and plasticizer as an aqueous solution. The aqueous solution comprising metal species may be added dropwise to the aqueous solution comprising the oxide species, metal dopant species, chelating agent and plasticizer. The aqueous solution comprising silver metal species may be added dropwise to the aqueous solution comprising the cerium metal species, metal dopant species, chelating agent and plasticizer. In some embodiments, the metal species may be provided in the aqueous solution at a concentration of at least about 0.01, 0.02, 0.03, 0.04, 0.05, 0.06, 0.07, 0.08, 0.09, 0.1, 0.2, 0.3, 0.4, 0.5 or 1.0 M. In some embodiments, the metal species may be provided in the aqueous solution at a concentration of less than about 1.0, 0.5, 0.4, 0.3, 0.2 0.1, 0.09, 0.08, 0.07, 0.06, 0.05, 0.04, 0.03, 0.02, or 0.01 M. Combinations of any two or more of these upper and/or lower concentrations are also possible, for example, the metal species may be provided in the aqueous solution at a concentration of between about 0.01 to 0.1 M. In some embodiments, the silver metal species may be provided in the aqueous solution at a concentration of at least about 0.01, 0.02, 0.03, 0.04, 0.05, 0.06, 0.07, 0.08, 0.09, 0.1, 0.2, 0.3, 0.4, 0.5 or 1.0 M. In some embodiments, the silver metal species may be provided in the aqueous solution at a concentration of less than about 1.0, 0.5, 0.4, 0.3, 0.2 0.1, 0.09, 0.08, 0.07, 0.06, 0.05, 0.04, 0.03, 0.02, or 0.01 M. Combinations of any two or more of these upper and/or lower concentrations are also possible, for example, the silver metal species may be provided in the aqueous solution at a concentration of between about 0.01 to 0.1 M.

The aqueous solution comprising the metal species may be added to the aqueous solution comprising the oxide species, metal dopant species, chelating agent and plasticizer at temperature of at least 50, 60, 70, 80, 90 or 100° C., for example between about 60° C. to 90° C. or 70° C. to 85° C. The aqueous solution comprising the metal species may be added to the aqueous solution comprising the oxide species, metal dopant species, chelating agent and plasticizer under stirring at a rate of at least 100, 200, 300, 400 or 500 rpm, for example between about 300 to 500 rpm.

The aqueous solution comprising the silver metal species may be added to the aqueous solution comprising the cerium metal species, metal dopant species, chelating agent and plasticizer at temperature of at least 50, 60, 70, 80, 90 or 100° C., for example between about 60° C. to 90° C. or 70° C. to 85° C. The aqueous solution comprising the silver metal species may be added to the aqueous solution comprising the cerium metal species, metal dopant species, chelating agent and plasticizer under stirring at a rate of at least 100, 200, 300, 400 or 500 rpm, for example between about 300 to 500 rpm.

### Heating the Gel to Obtain Hybrid Electrode Particles

The gel is heated at step b) to obtain a powder composition comprising the hybrid electrode particles, i.e. the electrode composition as described herein. This heating step is essentially the thermal decomposition of the gel (i.e. the precursor material comprising the chelated metal species immobilized as a gel) to burn off and remove the organic components (e.g. pyrolyse) of the gels to obtain the powder composition comprising the hybrid electrode particles.

Depending on whether the gel is aged to remove aqueous solution prior to heating at step b), the gel may be a viscous liquid or a rigid gel. It will be appreciated that both physical states are still considered a gel for the purposes of the present disclosure.

The gel at step b) may be heated to a suitable temperature effective to pyrolyse the organic components of the gel to obtain the powder composition of hybrid electrode particles. In some embodiments, the gel is heated in step b) at a temperature of at least about 300, 350, 400, 450, 500, 550, 600, 650, or 700° C. The gel may be heated in step b) at a temperature of less than about 700, 650, 600, 550, 500, 450, 400, 350 or 300° C. Combinations of any two or more of these upper and/or lower temperatures are also possible, for example the gel is heated in step b) at a temperature of between about 300° C. to about 450° C. In one embodiment, the gel is heated in step b) at a temperature of about 300, 350, 400, 450 or 500° C., for example about 450° C. Any suitable heating rate may be used, for example of at least or about 100, 120, 140, 150, 170, 180, 200, or 250° C./hour. In some embodiments, the gel is heated in step b) for a period of time of at least about 10, 15, 30, 45, min, 1, 2, 3, 4, 5, 6, 12, 24, 36, or 48 hours. In some embodiments, the gel is heated in step b) for a period of time of less than about 48, 36, 24, 12, 6, 5, 4, 3, 2, 1 hour, 45, 30, 15 or 10 min. The gel may be heated for a period of time in a range provided by any two of these upper and/or lower values, for example between about 1 hour to about 24 hours, for example between about 1 hours to about 10 hours, e.g. between about 2 hours to about 4 hours. Combinations of any one or more of the above temperatures and times are possible, for example, the gel may be heated in step b) at a temperature of between about 300° C. to 600° C. and for a period of time of between about 2 hours to 4 hours.

The heating (e.g. pyrolysis) may be performed using a suitable furnace or hotplate. Alternatively, the heating may be performed using spray pyrolysis or spray drying of the gel. It will be appreciated that where spray pyrolysis of the gel is desired, it is not necessary to age the gel to remove the aqueous solution prior to any pyrolysis, as the gel is required to still be flowable in order to spray pyrolyse/dry.

In some embodiments, the gel prepared at step a) may be deposited on a suitable substrate (e.g. by spin coating, dip coating etc.) then subjected to heat treatment to decompose the organic components to form a powder composition layer comprising hybrid electrode particles on the substrate.

The powder composition may be an amorphous, semi-crystalline or crystalline powder composition. For example, the hybrid electrode particles may be amorphous, semi-crystalline or crystalline. In one embodiment, the powder composition is an amorphous powder composition comprising hybrid electrode particles.

In some embodiments, the powder composition comprising the hybrid electrode particles, i.e. the electrode composition as described herein, may be further processed into a dry powder formulation or wet coating formulation comprising one or more solvents. The wet coating formulation may be a dip coating formulation or printable ink formulation as described herein.

### Sintered Powder Composition or Formulations Thereof

The powder composition or coating formulation thereof comprising the hybrid electrode particles may be sintered forming a sintered electrode material as described herein. In one embodiment, the sintering comprises heating the powder composition or coating formulation comprising the hybrid electrode particles to a temperature effective to coalesce and adhere the metal particles of the hybrid electrode particles to each other to form a continuous or semi-continuous metal phase. Following sintering to form the metal phase (i.e. a scaffold comprising the porous silver metal phase), the metal doped oxide particles (e.g. metal doped ceria particles) may remain as discrete particles attached to the surface of the metal phase (e.g. silver) and/or may also adhere to other metal doped oxide particles (e.g. metal doped ceria particles) to form one or more discrete metal doped oxide phases (e.g. portions) attached to the surface of the metal phase (e.g. silver). The sintered electrode material comprises a metal phase (e.g. silver) as a porous scaffold and plurality of discrete metal doped oxide phases (e.g. metal doped ceria particles) interspersed within the metal phase (e.g. silver).

In one embodiment, the sintering is at a temperature (in ° C.) of between about 100 to about 900. In one embodiment, the sintering is at a temperature (in ° C.) of at least about 100, 200, 300, 400, 500, 700, or 900. In one embodiment, the sintering is at a temperature (in ° C.) of less than about 900, 700, 500, 400, 300, 200 or 100. The sintering temperature may be in a range provide by any two of these upper and/or lower values, for example between about 400° C. to about 900° C.

In one embodiment, the sintering is at a heating rate (in ° C./hour) of between about 50 to 300, between about 100 to 200, or between about 150 to 180. The sintering may be at a heating rate (in ° C./hour) of at least about 50, 70, 100, 120, 150, 180, 200, 250 or 300. The sintering may be at a heating rate (in ° C./hour) of less than about 300, 250, 200, 180, 150, 120, 100, 70 or 50. The sintering heating rate may be in a range provide by any two of these upper and/or lower values. The sintering may be performed using any suitable apparatus, for example a sintering furnace or high temperature furnace or oven.

In one embodiment, the process further comprises fabricating an electrode. For example, an electrode may be fabricated using the powder composition or sintered electrode material thereof. The electrode may be used in a solid oxide electrolysis cell or a solid oxide fuel cell.

In one embodiment, the process further comprises preparing a solid oxide electrochemical cell comprising an electrode comprising the powder composition or a sintered electrode material thereof. The solid oxide electrochemical cell may comprise a positive electrode and a negative electrode each comprising the powder composition or the sintered electrode material thereof. For example, the powder composition or the sintered electrode material thereof may be used as both the positive and negative electrodes, for example to form a symmetrical and reversible solid oxide electrochemical cell. This allows for faster fabrication of the solid oxide electrochemical cell as both the positive and negative electrode can be heat treated (e.g. sintered) at the same time when preparing the solid oxide electrochemical cell. The heat treatment can also be at lower temperatures than conventional processes used to prepare conventional electrodes for solid oxide electrochemical cells. The method of manufacturing a solid oxide electrochemical cell is described below.

### Electrodes and Solid Oxide Electrochemical Cells

The present disclosure also provides an electrode comprising the electrode composition comprising the hybrid electrode particles described herein or a sintered electrode material thereof, which can be used as an electrode in a solid oxide electrochemical cell.

The present disclosure also provides an electrode comprising the electrode composition described herein or the sintered electrode material thereof, which can be used as an electrode in a solid oxide electrochemical cell. The general components of a solid oxide electrochemical cell are well known and understood in the art of the present disclosure. The solid oxide electrochemical cell comprises:
a positive electrode;
a negative electrode;
a solid electrolyte which is in solid communication with the positive and negative electrode; and
an electrical circuit connecting the positive and negative electrode.

The positive electrode may also be referred to as the anode, and the negative electrode may also be referred to as the cathode. These electrodes function as either a cathode or anode depending on if the solid oxide electrochemical cell is running in regenerative mode (e.g. for a solid oxide electrolysis cell (SOEC)) or energy production mode (e.g. for a solid oxide fuel cell (SOFC).

In one embodiment, the solid oxide electrochemical cell may be a solid oxide electrolysis cell (SOEC). The basic operation of a solid oxide electrolysis cell is described as follows: an input stream (e.g. CO₂ and H₂O)) flows into the cell through an inlet and into the negative electrode (e.g. fuel electrode or cathode). When a voltage is applied, the input stream (e.g. CO₂ and H₂O) is reduced within the negative electrode (e.g. syngas: CO and H₂) and mobile oxygen species e.g. oxygen ions (O²⁻), which flow towards the solid oxide electrolyte. The oxygen ions travel through the solid oxide electrolyte and into the positive electrode (e.g. oxygen electrode or anode) where the oxygen ions are oxidised to molecular oxygen (O₂) and creates electrons (e⁻). These electrons flow from the positive electrode (i.e. anode) into an electrical circuit back to the negative electrode (i.e. cathode), and the negative electrode uses the electrons to reduce oxygen atoms and start the process all over again.

It has been found that the SOEC, as described herein, can directly produce fuel gases without requirement of any additional reducing gas, such as H₂ or CO in the feed stream. With the state of the art/conventional materials, additional supply of the reducing gas is required during start and shutdown to prevent oxidation of the cathode, for example, nickel into nickel oxide, which leads to performance degradation. Advantageously, no additional reducing gas is required to maintain the metallic nature of the hybrid electrodes as the electrode composition or sintered electrode material, as described herein, are efficient and stable in both oxidizing and reducing environment. Additionally, the hybrid electrodes described herein, require less electrical energy per unit volume of hydrogen or carbon monoxide, or a mixture of both (syngas), as compared to conventional Ni—YSZ electrodes.

In an alternative embodiment, the solid oxide electrochemical cell may be a solid oxide fuel cell (SOFC). A SOFC is a SOEC run in reverse that produces electricity directly from oxidizing a fuel. The basic operation of a solid oxide fuel cell is described as follows: air flows into the cell through an inlet. As the air flows past the negative electrode (e.g. oxygen electrode or cathode), oxygen atoms are reduced within the cathode to create oxygen ions (O²⁻) which flow towards the solid oxide electrolyte. The oxygen ions travel through the solid oxide electrolyte and into the positive electrode (e.g. fuel electrode or anode), and then react with a fuel source (e.g. hydrogen gas) at the positive electrode. The reaction between the oxygen ions and the hydrogen gas at the positive electrode creates H₂O and electrons (e⁻). These electrons flow from the positive electrode (i.e. anode) into an electronic circuit and back into the negative electrode (i.e. cathode). The electronic circuit uses the flow of electrons to power a device and the negative electrode uses the electrons to reduce oxygen atoms and start the process all over again.

One or more advantages of the present disclosure according to at least some embodiments or examples as described herein is that the same electrode composition or sintered electrode material thereof can be used for both the positive electrode and negative electrode in a solid oxide electrochemical cell and reduce time and cost of, for example, SOEC/SOFC fabrication. It will be appreciated that, typically, different materials are used for the fabrication of the negative electrode (e.g. nickel-YSZ composite) and positive electrode (e.g. LSM-YSZ composite) for state of the art solid oxide electrolysis cells. As such, the temperature used for heat treatment during the fabrication process is different when two different materials are used, and a two-step processing is required where negative electrode is typically fabricated using heat treatment at 1500° C. followed by positive electrode typically fabricated at 900 to 1100° C. In contrast, one advantage of using the same material for both the positive and negative electrode is that the electrodes can be manufactured in a single step.

Advantageously, as mentioned above, the same electrode composition or sintered electrode material thereof can be used for both positive and negative electrode which is one of the major constraints with existing SOE technology. In addition, the electrode composition or sintered electrode material thereof as described herein has been unexpectedly found to be less susceptible to degradation issues due to its stability in both fuel and oxidizing environments, and therefore could find use in multiple heterogeneous applications.

It will be appreciated that this approach could also lower the solid oxide cell operation temperature for desired conversion rates and reduce the overall volume and cost of solid oxide cell fabrication. Also, solid oxide cell fabrication/capital cost and time can be significantly reduced due to the advantageous symmetrical cell configuration.

In some embodiments, the solid oxide electrochemical cell is a tubular solid oxide electrochemical cell. Some of the additional advantages of the present disclosure according to at least some embodiments or examples as described herein is that the tubular cell structure could provide increased durability, prolonged life, and improved performance, while allowing integration with intermittent renewable energy sources compared to planar cell structures. For example, in use, the tubular cell structure of a SOEC can advantageously provide improved heat dissipation (e.g. an electrolyser can be ramped up in less than 30 minutes) and can be used effectively in transient power management schemes to convert excess electrical production to, for example, hydrogen.

In some embodiments, the electrode compositions or sintered electrode material thereof can be used as the positive electrode and/or negative electrode in a solid oxide electrochemical cell. In one embodiment, the electrode compositions or sintered electrode material thereof can be used as both the positive and the negative electrode of a solid oxide electrochemical cells.

Accordingly, the present disclosure also provides a solid oxide electrochemical cell comprising a cathode, a solid oxide electrolyte, and an anode, wherein the cathode and/or the anode comprise the electrode composition as described herein, or a sintered electrode material thereof as described herein.

### Electrode Compositions

In some embodiments, the positive electrode or negative electrode comprise an electrode composition or sintered electrode material thereof as described herein. For example, the positive electrode and the negative electrode are the same electrode material. It will be understood that such arrangement is referred to as a symmetrical solid oxide electrochemical cell. The sintered electrode material may be produced by heating (e.g. firing) the electrode composition comprising the hybrid electrode particles so that the metal particles (e.g. silver) of the hybrid electrode particles coalesce and adhere to each other, to form a continuous or semi-continuous metal phase (e.g. silver) within the electrode material.

The metal phase may comprise at least one metallic particle selected from silver (Ag), iron (Fe), nickel (Ni) and cobalt (Co). In some embodiments, the metal phase may comprise a combination of silver (Ag) particles and one or more of iron (Fe), nickel (Ni), cobalt (Co), copper (Cu), and titanium (Ti). The silver metal phase may comprise one or more silver metal portions. In some embodiments, the metal phase is a porous scaffold. In some embodiments, the silver metal phase is a porous scaffold. In some embodiments, the sintered electrode material comprises a metal phase as a porous scaffold and plurality of discrete metal doped oxide phases interspersed within the metal phase. The discrete metal doped oxide phase may be in the form of metal doped oxide particles as described herein. The discrete metal doped oxide phases (e.g. particles or portions) may be interspersed within the metal phase. In one embodiment, the sintered electrode material comprises a silver metal phase as a porous scaffold and plurality of discrete metal doped ceria phases interspersed within the silver metal phase. The discrete metal doped ceria phase may be in the form of metal doped ceria particles as described herein. The discrete metal doped ceria phases (e.g. particles or portions) may be interspersed within the silver metal phase. The sintered electrode material of the cathode and/or anode may be a sintered electrode material as described herein in relation to the electrode compositions. The electrode composition or sintered electrode material thereof may be a coating on an electrode support.

### Positive Electrode

The positive electrode may also be called the anode. When used in a SOEC, the anode may also be called the oxygen electrode. When used in a SOFC, the anode may also be called the fuel electrode. In some embodiments, the electrode compositions or a sintered electrode material thereof can be used as the positive electrode. Alternatively, according to some embodiments or examples, where the electrode compositions or a sintered electrode material thereof is used as the negative electrode, any conventional electrode material used in solid oxide electrochemical cells can be used as the positive electrode. The positive electrode may be porous to provide for a uniform flow of oxygen throughout the electrode. The positive electrode may also be any suitable material capable of conducting oxide ions (O²⁻) to the solid oxide electrolyte.

In some embodiments, where the negative electrode comprises the electrode compositions or a sintered electrode material thereof, the positive electrode may be selected from lanthanum strontium manganite (LSM), lanthanum strontium cobalt ferrite (LSCF), strontium samarium cobalt oxide (SSC), lanthanum strontium iron oxide (LSF), lanthanum strontium cobalt oxide (LSCO), barium strontium cobalt iron oxide(BSCF), or combinations thereof, and also composites thereof with yttria stabilized zirconia (YSZ), scandia stabilized zirconia (SSZ), gadolinia doped ceria (GDC), samaria doped ceria (SDC), samaria-neodymium doped ceria (SNDC), erbia stabilized bismuth oxide (ESB), yttria stabilized bismuth oxide (YSB), strontium and magnesium doped lanthanum gallate (LSGM). In one embodiment, the positive electrode comprises the electrode compositions or a sintered electrode material thereof as described herein.

### Negative Electrode

The negative electrode may also be called the cathode. When used in a SOEC, the cathode may also be called the fuel electrode. When used in a SOFC, the cathode may also be called the oxygen electrode. In some embodiments, the electrode compositions or a sintered electrode material thereof can be used as the negative electrode. Alternatively, according to some embodiments or examples, where the electrode compositions or a sintered electrode material is used as the positive electrode, any conventional electrode material used in solid oxide electrochemical cells can be used as the negative electrode. The negative electrode may be a porous layer that allows fuel gas/reactant gas to flow throughout the electrode, and in some embodiments is both electrically and ionically conductive.

In some embodiments, where the positive electrode comprises the electrode compositions or a sintered electrode material thereof, the negative electrode may comprise a combination of ceramic and metal (cermet) prepared by standard ceramic processing techniques. Non-limiting examples of cermets that can be used as the negative electrode include nickel-yttria stabilized zirconia (Ni—YSZ), nickel-gadolinium doped ceria (Ni-GDC), nickel-ytrria doped ceria zirconia (Ni-YDCZ), and Copper-Ceria-yttria doped zirconia (Cu—CeO₂—YSZ). Other suitable negative electrode materials lanthanum strontium manganese chromium oxide (LSCM), lanthanum strontium ferrites (LSF), lanthanum strontium titanates (LST) and vanadates (LSV). In one embodiment, the negative electrode comprises the electrode compositions or a sintered electrode material thereof as described herein.

### Solid Oxide Electrolyte

The solid oxide electrolyte may be selected from any conventionally known electrolyte capable of diffusing oxygen ions between the cathode and anode of a solid oxide electrochemical cell. Examples of suitable solid oxide electrolytes include, but are not limited to, yttria stabilized zirconia (YSZ), scandia stabilized zirconia (SSZ), gadolinia doped ceria (GDC), samaria doped ceria (SDC), samaria-neodymium doped ceria (SNDC), erbia stabilized bismuth oxide (ESB), yttria stabilized bismuth oxide (YSB), strontium and magnesium doped lanthanum gallate (LSGM), and combinations thereof. In one embodiment, the solid oxide electrolyte is yttria stabilized zirconia (YSZ). The solid oxide electrolyte may also be provided as one or more layers, wherein each layer may independently be selected from a solid oxide electrolyte described above.

### Additional Components

The solid oxide electrochemical cells may comprise one or more additional components. This may include a current collector (such as silver paste, platinum paste, silver mesh, silver wire, and platinum mesh), power source, and/or interconnects. It will be appreciated that other additional components may be present as understood by the person skilled in the art.

### Applications

In one embodiment, the solid oxide electrochemical cell is a solid oxide electrolysis cell (SOEC) configured for the synthesis of one or more of oxygen, hydrogen, carbon-monoxide, or syngas.

In one embodiment, the solid oxide electrochemical cell is a solid oxide fuel cell (SOFC) for conversion of chemical energy from one of more of hydrogen, ammonia, hydrocarbon (e.g. methane), natural gas, alcohol (e.g. methanol or ethanol), syngas, solid carbon, and biomass SOFC into electric and/or thermal energy.

The present disclosure also provides use of the electrode composition or a sintered electrode material thereof as described herein in preparing an electrode or electrode material for a solid oxide electrochemical cell as described herein.

In some embodiments, the electrode comprising the electrode composition or a sintered electrode material thereof as described herein or solid oxide electrochemical cell as described herein may have a low electrode polarization resistance. In some embodiments, the electrode polarization resistance (Ohms-cm² at 1.2 volts applied potential) may be less than about 0.5, 0.4, 0.3, 0.2, 0.1, 0.05 or 0.01. The electrode polarization resistance (Ohms-cm² at 1.2 volts applied potential) may be greater than about 0.01, 0.05, 0.1, 0.2, 0.3, 0.4 or 0.5. Combinations of these values are also possible, for example between about 0.01 to 0.5, 0.05 to 0.4 or 0.1 to 0.3. The electrode polarization resistance may be less than about 0.2. The electrode polarization resistance can be measured using ASTM G59-97.

In some embodiments, the electrode comprising the electrode composition or a sintered electrode material thereof as described herein facilitates electrolysis of steam and/or carbon dioxide to produce hydrogen and/or carbon monoxide, for example when used as the positive and negative electrode in a symmetrical cell. In other embodiments, the electrode comprising the electrode composition or a sintered electrode material thereof as described herein can be applied in solid oxide electrolysis-based ammonia synthesis and one step methane synthesis.

Electrochemical cells (e.g. solid oxide electrochemical cells) fabricated using an electrode comprising the electrode composition or a sintered electrode material thereof as described herein can demonstrate enhanced performance and/or improved stability, according to at least some examples or embodiments described herein.

In some embodiments, the electrochemical cell fabricated using an electrode comprising the electrode composition or a sintered electrode material thereof as described herein can maintain performance over at least 100, 200, 300, 400 or 500 redox cycles, highlighting the electrochemical cells enhanced performance and/or improved stability.

In some embodiments, the electrochemical cells fabricated using an electrode comprising the hybrid electrode particles as described herein can have at least 5%, 10%, 15%, 20%, 25%, 30%, 35% or 40% higher performance compared to electrochemical cells fabricated using electrodes made by mixing discrete ceria and metallic silver particles. Combinations of these values are also possible to form a range for example between 5% to 40% higher performance.

In some embodiments, the electrochemical cells fabricated using an electrode comprising the hybrid electrode particles as described herein can have at least 5%, 10%, 15%, 20%, 25% 30%, 35% or 40% lower electrode polarisation resistance compared to electrochemical cells fabricated using electrodes made by mixing discrete ceria and metallic silver particles. Combinations of these values are also possible to form a range, for example between 25% to 40% lower electrode polarisation resistance. A lower electrode polarisation provides improved kinetics and performance.

### Method of Making the Electrochemical Cell

The present disclosure also provides for a method of making an electrochemical cell comprising at least one electrode which comprises an electrode composition comprising the hybrid electrode particles as described herein, or a sintered electrode material as described herein.

In one embodiment, there is provided a method of manufacturing a solid oxide electrochemical cell comprising:
a) preparing one or more solid oxide electrolyte layers;
b) applying an electrode composition to one or both sides of the solid oxide electrolyte layer(s) to form a solid oxide electrochemical cell component, wherein the electrode composition applied to at least one side of the solid oxide electrolyte layer(s) comprises an electrode composition as described herein; and
c) sintering the electrode composition applied onto the solid oxide electrochemical cell component to form an electrode or electrode material.

In one embodiment, step b) comprises applying the electrode composition to both sides of the solid oxide electrolyte layer. Any suitable process may be used to apply the electrode composition to the solid oxide electrolyte layer, for example by dip coating the solid oxide electrolyte layer into a wet coating formulation comprising the electrode composition to coat both sides of the layer with the electrode composition for forming the positive and negative electrode, respectively, on the solid oxide electrolyte layer.

The sintering of the solid oxide electrochemical cell component comprising the electrode composition may be performed as described herein in relation to the sintering of the electrode composition.

In another embodiment, there is provided a method of manufacturing a solid oxide electrochemical cell comprising:
a) preparing one or more solid oxide electrolyte layers;
b) applying a sintered electrode material to one or both sides of the solid oxide electrolyte layer(s) to form a solid oxide electrochemical cell component, wherein the sintered electrode material applied to at least one side of the solid oxide electrolyte layer(s) comprises a sintered electrode material as described herein.

In one embodiment, the solid oxide electrochemical cell is a symmetrical cell comprising a positive and a negative electrode on opposing sides of the solid oxide electrolyte layer(s) each electrode comprising or consisting of the electrode composition as described herein, or a sintered electrode material thereof.

Any one of the following numbered paragraphs, or any combination of these paragraphs, can provide further embodiments of the present disclosure:
1. An electrode composition comprising a plurality of hybrid electrode particles, wherein each hybrid electrode particle comprises a silver particle having a surface comprising one or more metal doped ceria particles.
2. The electrode composition according to any one or more embodiments described herein, wherein the one or more metal doped ceria particles are decorated on the surface of the silver particle.
3. The electrode composition according to any one or more embodiments described herein, wherein the particle size of the silver particles are greater than the particle size of the metal doped ceria particles.
4. The electrode composition according to any one or more embodiments described herein, wherein the hybrid electrode particles have a particle size (in μm) of between about 0.1 to 5.
5. The electrode composition according to any one or more embodiments described herein, wherein the silver particle of each hybrid electrode particle has a particle size (in μm) of between about 0.1 to 3.
6. The electrode composition according to any one or more embodiments described herein, wherein the metal doped ceria particles on the surface of the silver particle have a particle size (in nm) of between about 1 to 200.
7. The electrode composition according to any one or more embodiments described herein, wherein the metal dopant for the ceria particles is provided by one or more metals selected from rare-earth metals and alkaline earth metals.
8. The electrode composition according to any one or more embodiments described herein, wherein the metal dopant for the ceria particles is provided by one or more metals selected from samarium (Sm), gadolinium (Gd), lanthanum (La), zirconium (Zr), yttrium (Y), ytterbium (Yb), erbium (Er), praseodymium (Pr) or neodymium (Nd).
9. The electrode composition according to any one or more embodiments described herein, wherein the metal dopant for the ceria particles is provided by one or more metals selected from, gadolinium (Gd) samarium (Sm) and yttrium (Y).
10. The electrode composition according to any one or more embodiments described herein, wherein the amount of the metal dopant in the ceria particles (w/w % based on total weight of metal doped ceria particles) is between about 1 to 35.
11. The electrode composition according to any one or more embodiments described herein, wherein the metal doped ceria particles have a formula Ce₁₋ₓMₓO_{2-δ} wherein x is between about 0.01 to 0.3, M is one or more dopants as defined above, and δ is between about 0.0 and 0.5.
12. The electrode composition according to any one or more embodiments described herein, wherein the composition is provided as a coating formulation comprising the hybrid electrode particles as a powder present in one or more solvents.
13. The electrode composition according to any one or more embodiments described herein, wherein the coating formulation is a dip coating formulation comprising the powder, one or more organic solvents, and optionally one or more binders.
14. The electrode composition according to any one or more embodiments described herein, wherein the coating formulation is a printable ink formulation comprising the powder, one or more organic solvents, and optionally one or more binders.
15. The electrode composition according to any one or more embodiments described herein, wherein the electrode composition is provided as a sintered electrode material.
16. The electrode composition according to any one or more embodiments described herein, wherein the sintered electrode material comprises a silver metal phase as a porous scaffold and plurality of discrete metal doped ceria phases interspersed within the silver metal phase.
17. The electrode composition according to any one or more embodiments described herein, wherein the discrete metal doped cerium oxide phase is in the form of metal doped cerium oxide particles.
18. The electrode composition according to any one or more embodiments described herein, wherein the sintered electrode material comprises between about 10 to 100 discrete metal doped ceria phases per cm³ of silver metal phase.
19. The electrode composition according to any one or more embodiments described herein, wherein the sintered electrode material has a porosity (in vol %) based on the total volume of sintered electrode material of between about 10 to 60.
20. The electrode composition according to any one or more embodiments described herein, wherein the thickness of the sintered electrode material (in μm) is between 1 and 100.
21. A modified sol-gel process for preparing hybrid electrode particles, wherein the process comprises:
a) preparing a gel from an aqueous solution comprising a silver metal species, a cerium metal species, a metal dopant species, a plasticizer, and a chelating agent; and
b) heating the gel to obtain a powder composition comprising the hybrid electrode particles.
22. The modified sol-gel process according to any one or more embodiments described herein, wherein step a) comprises preparing an aqueous solution comprising the cerium metal species and the metal dopant species, followed by addition of the chelating agent, plasticizer, and then silver metal species to the aqueous solution.
23. The modified sol-gel process according to any one or more embodiments described herein, wherein the aqueous solution comprising the cerium metal species, metal dopant species, chelating agent and plasticizer is aged prior to the addition of the silver metal species.
24. The modified sol-gel process according to any one or more embodiments described herein, wherein after step a) but prior to step b) the process comprises aging the gel for a period of time and suitable temperature prior to the heating at step b) to any residual aqueous solution.
25. The modified sol-gel process according to any one or more embodiments described herein, wherein the aqueous solution and/or gel is aged for a period of time of between about 12 hours to 36 hours and at a temperature of between about 60° C. to 90° C.
26. The modified sol-gel process according to any one or more embodiments described herein, wherein one or more of the cerium metal species, metal dopant species, and silver metal species, is provided as salts or hydrates thereof independently selected from hydroxides, chlorides, nitrates, and oxide salts.
27. The modified sol-gel process according to any one or more embodiments described herein, wherein one or more of the cerium metal species, metal dopant species, and silver metal species, is provided as nitrate salts or hydrates thereof.
28. The modified sol-gel process according to any one or more embodiments described herein, wherein the cerium metal species and metal dopant species are each provided in the aqueous solution at a concentration of between about 0.01 and 0.1 M.
29. The modified sol-gel process according to any one or more embodiments described herein, wherein the silver metal species is provided in the aqueous solution at a concentration between about 0.01 and 0.1 M.
30. The modified sol-gel process according to any one or more embodiments described herein, wherein the molar ratio of silver metal species to cerium metal species is about 1:5 to 5:1.
31. The modified sol-gel process according to any one or more embodiments described herein, wherein the molar ratio of metal dopant species to cerium metal species is about 1:50 to 1:1.
32. The modified sol-gel process according to any one or more embodiments described herein, wherein the plasticizer is a glycol, preferably selected from ethylene glycol, diethylene glycol, and triethylene glycol.
33. The modified sol-gel process according to any one or more embodiments described herein, wherein the chelating agent is selected from carboxylic acids (e.g. citric acid), amines, amino acids, aminopolycarboxylic acids (e.g. EDTA), diesters, β-diketones, β-ketoesters, and any combinations thereof.
34. The modified sol-gel process according to any one or more embodiments described herein, wherein the molar ratio of chelating agent to silver metal species is between about 1:5 to 5:1.
35. The modified sol-gel process according to any one or more embodiments described herein, wherein the gel is heated in step b) at a temperature of between about 300° C. to 600° C.
36. The modified sol-gel process according to any one or more embodiments described herein, wherein step b) comprises flame spray pyrolysis or spray drying of the gel obtained from step a) to obtain the powder composition of hybrid electrode particles.
37. The modified sol-gel process according to any one or more embodiments described herein, wherein the powder composition comprising the hybrid electrode particles is further processed into a dry powder formulation or wet coating formulation comprising one or more solvents.
38. The modified sol-gel process according to any one or more embodiments described herein, wherein the coating formulation is a dip coating formulation comprising one or more solvents.
39. The modified sol-gel process according to any one or more embodiments described herein, wherein the coating formulation is a printable ink formulation comprising the powder, one or more organic solvents, and one or more stabilisers.
40. The modified sol-gel process according to any one or more embodiments described herein, wherein the powder composition or formulation thereof is sintered into a sintered electrode material.
41. The modified sol-gel process according to any one or more embodiments described herein, wherein the sintering is at a temperature of between about 500° C. to 900° C.
42. The modified sol-gel process according to any one or more embodiments described herein, wherein the sintered electrode material comprises a silver metal phase as a porous scaffold and plurality of discrete metal doped ceria phases interspersed within the silver metal phase.
43. The modified sol-gel process according to any one or more embodiments described herein, wherein an electrode is fabricated using the powder composition or a sintered electrode material thereof.
44. The modified sol-gel process according to any one or more embodiments described herein, wherein a solid oxide electrochemical cell is prepared comprising an electrode comprising the powder composition or a sintered electrode material thereof.
45. The modified sol-gel process according to any one or more embodiments described herein, wherein the solid oxide electrochemical cell comprises a positive electrode and a negative electrode each comprising the powder composition or a sintered electrode material thereof.
46. An electrode comprising the electrode composition according to any one or more embodiments described herein or a sintered electrode material thereof.
47. A solid oxide electrochemical cell comprising a cathode, a solid oxide electrolyte, and an anode, wherein the cathode and/or the anode comprise the electrode composition according to any one or more embodiments described herein or a sintered electrode material thereof.
48. The electrode or solid oxide electrochemical cell according to any one or more embodiments described herein, wherein the sintered electrode material of the electrode composition comprises a silver metal phase as a porous scaffold and plurality of discrete metal doped ceria phases interspersed within the silver metal phase.
49. The electrode or solid oxide electrochemical cell according to any one or more embodiments described herein, wherein the discrete metal doped cerium oxide phase is in the form of metal doped cerium oxide particles.
50. The electrode or solid oxide electrochemical cell according to any one or more embodiments described herein, wherein the metal doped cerium oxide particles have a particle size (in nm) of between about 1 to 200.
51. The electrode or solid oxide electrochemical cell according to any one or more embodiments described herein, wherein the electrode composition or sintered electrode material thereof is coated on an electrode support.
52. The electrode or solid oxide electrochemical cell according to any one or more embodiments described herein, wherein the sintered electrode material has a porosity (in vol %) based on the total volume of sintered electrode material of between about 10 to 60.
53. The electrode or solid oxide electrochemical cell according to any one or more embodiments described herein, wherein the sintered electrode material comprises between about 50 to 500 discrete metal doped ceria phases per cm³ of silver metal phase.
54. The solid oxide electrochemical cell according to any one or more embodiments described herein, wherein the solid oxide electrolyte is selected from yttria stabilized zirconia (YSZ), scandia stabilized zirconia (SSZ), gadolinia doped ceria (GDC), samaria doped ceria (SDC), samaria-neodymium doped ceria (SNDC), erbia stabilized bismuth oxide (ESB), yttria stabilized bismuth oxide (YSB), strontium or magnesium doped lanthanum gallate (LSGM), and combinations thereof.
55. The solid oxide electrochemical cell according to any one or more embodiments described herein, wherein the solid oxide electrochemical cell is a solid oxide electrolysis cell (SOEC), a solid oxide fuel cell (SOFC), or a reversible solid oxide electrochemical cell.
56. The solid oxide electrochemical cell according to any one or more embodiments described herein, wherein the solid oxide electrochemical cell is a solid oxide electrolysis cell (SOEC) configured for the synthesis of one or more of oxygen, hydrogen, carbon monoxide, or syngas.
57. The solid oxide electrochemical cell according to any one or more embodiments described herein, wherein the solid oxide electrochemical cell is a solid oxide fuel cell (SOFC) for conversion of chemical energy from one of more of a hydrogen, ammonia, hydrocarbon, alcohol, syngas, solid carbon, and biomass SOFC into electric and/or thermal energy.
58. The solid oxide electrochemical cell according to any one or more embodiments described herein, wherein the solid oxide electrochemical cell is a symmetrical solid oxide electrochemical cell having a positive electrode and a negative electrode, each electrode comprising the electrode composition or a sintered electrode material thereof.
59. Use of the electrode composition according to any one or more embodiments described herein or a sintered electrode material thereof in preparing an electrode or electrode material for a solid oxide electrochemical cell.
60. The use according to any one or more embodiments described herein, wherein the solid oxide electrochemical cell is a solid oxide electrolysis cell (SOEC), a solid oxide fuel cell (SOFC), or a reversible solid oxide electrochemical cell.
61. The use according to any one or more embodiments described herein, wherein the solid oxide electrochemical cell is a solid oxide electrolysis cell (SOEC) configured for the synthesis of one or more of oxygen, hydrogen, carbon monoxide, or syngas.
62. The use according to any one or more embodiments described herein, wherein the solid oxide electrochemical cell is a solid oxide fuel cell (SOFC) selected from a hydrogen, ammonia, hydrocarbon, alcohol, syngas, solid carbon, and biomass SOFC.
63. The use according to any one or more embodiments described herein, wherein the solid oxide electrochemical cell is a symmetrical solid oxide electrochemical cell having a positive electrode and a negative electrode, each electrode comprising the electrode composition or a sintered electrode material thereof.
64. A method of manufacturing a solid oxide electrochemical cell comprising:
a) preparing one or more solid oxide electrolyte layers;
b) applying an electrode composition to one or both sides of the solid oxide electrolyte layer(s) to form a solid oxide electrochemical cell component, wherein the electrode composition applied to at least one side the solid oxide electrolyte layer(s) comprises an electrode composition according to any one or more embodiments described herein; and
c) sintering the electrode composition applied onto the solid oxide electrochemical cell component to form an electrode or electrode material.
65. The method of claim 64, wherein step b) comprises applying an electrode composition according to any one or more embodiments described herein to both sides of the solid oxide electrolyte layer.
66. The method according to any one or more embodiments described herein, wherein the solid oxide electrochemical cell is a symmetrical cell comprising a positive and a negative electrode on opposing sides of the solid oxide electrolyte layer(s) each electrode comprising or consisting of the electrode composition according to any one or more embodiments described herein.

### EXAMPLES

The present disclosure is further described by the following examples. It is to be understood that the following description is for the purpose of describing particular embodiments only and is not intended to be limiting with respect to the above description.

### Example 1: Preparation of Hybrid Electrode Particles

Cerium nitrate hexahydrate and gadolinium nitrate hexahydrate was dissolved in deionized water to form an aqueous solution having a concentration of cerium nitrate and gadolinium nitrate each between 0.01 to 0.1 M, for example 0.02 M. A chelating agent (e.g. Citric acid or EDTA) was then added to the aqueous solution having a molar ratio of citric acid to nitrate of about 1:1 to 1:5. The aqueous solution comprising cerium nitrate, gadolinium nitrate and chelating agent (e.g. citric acid and EDTA) was then mixed with a plasticizer (e.g. triethylene glycol) at a ratio of about 2:1 to 4:1 based on the species present in the aqueous solution (e.g. triethylene glycol rich). The aqueous solution then aged for 24 h to at temperature of 70 to 85° C. in a lab drying oven (with natural convection).

Similarly, aqueous solutions of lanthanum nitrate hexahydrate (0.100 M), strontium nitrate (0.067 M), cobalt nitrate hexahydrate (0.035 M) and iron nitrate nonahydrate (0.140 M) were prepared and mixed thoroughly using magnetic stirrer, followed by adding citric acid monohydrate (chelating agent) to the solution such that molar ratio of nitrates:citric acid was 1:1. Next, triethylene glycol (plasticizer) was added to the solution such that molar ratio of (nitrates+acid):triethylene glycol was 2:1. This liquid mixture was stirred thoroughly for 15 minutes to ensure dissolution of all the chemicals and then aged for 24 hours at temperature of 70 to 85° C. in a lab drying oven with natural convection.

Similarly, in another example as a bimetallic metal species and mixed oxide phase, aqueous solutions of silver nitrate (0.327 M) and iron nitrate nonahydrate (0.127 M) were mixed thoroughly and then added dropwise to the aqueous solution comprising cerium nitrate, gadolinium nitrate, chelating agent and plasticizer with all other steps remaining exactly the same.

In a separate beaker, an aqueous solution of silver nitrate at a concentration of about 0.01 to 0.1 M was prepared. The silver nitrate solution was added slowly (drop by drop) to the above aqueous solution comprising metal nitrates, chelating agent and plasticizer while stirring on a hotplate at 70 to 85° C. under constant stirring at 300 to 500 rpm on lab stirrer (e.g. Fisher Scientific). The mixed aqueous solution (which is still liquid, viscous but can flow) was further aged for 24 h to at temperature between 70 to 85° C. in drying oven and cooled down to room temperature, and further aged for 4 to 8 hrs to form the gel.

The gel mixture was then combusted on hot pyro glass surface maintained at 450° C. to burn the organic matter and obtain a powder composition comprising hybrid electrode particles with desired microstructure (e.g. pyrolysis).

### Example 2: Preparation of Solid Oxide Electrolysis (SOEC) Tube Cell

### Solid Oxide Electrolyte Tube

Ceramic 8 mol % Yttria-stabilized zirconia (YSZ) tubes were fabricated by cold isostatic pressing of 8YSZ powder at 170 MPa followed by sintering at 1500° C. for 4 h. The length and OD of the tube were ˜340 mm and ˜11 mm, respectively. The electrolyte tube thickness was measured to be ˜0.45 mm.

### Fuel Electrode (Negative Electrode) Coating

The ink for fuel electrode was prepared by mixing the powder composition (i.e. electrode composition as described herein) with terpineol based ink vehicle (FCM materials, USA) in the ratio of 65:35 wt %. The resulting slurry was ball milled for about 2 hours using zirconia balls.

A dip coating solution was also prepared using the powder composition of hybrid electrode particles, as follows:

TABLE 1
Dip coating formulation

| Component | Amount | |
|---|---|---|
| Hybrid electrode particles | 39 | g |
| (powder composition) | | |
| Polyvinyl butyral | 2.8 | g |
| α-Terpineol | 1.39 | g |
| Ethanol, | 16.74 | g |
| Total | ~60 | g |

The formulations were then applied to solid oxide electrolyte tube via dip coating or brush coating and sintered at 600 to 850° C. using heating and cooling rate of 120° C./h for 4 hours. The thickness of the sintered fuel electrode comprising the sintered hybrid electrode particles (i.e. sintered electrode material as described herein) was measured to be ˜40 μm thick with active area 25 cm².

For the tube cell using the prior art electrode, the electrode ink was prepared with commercially sourced Ni—YSZ powder (FCM materials, USA) by using similar procedure as described earlier. The heat treatment of prior art electrode was performed at 1400° C. for 2 hours and then cooled down to 25° C. as per standard state of the art conditions. The heating and cooling rate were 3° C./min. The electrode was ˜40 μm thick with an effective cell area of 25 cm².

### Oxygen Electrode (Positive Electrode)

For both prior art electrode and sintered hybrid electrode, the sintered hybrid electrode was used as air electrode. The electrode ink was prepared by mixing as synthesized powder with terpineol-based ink vehicle (Fuel Cell Materials Inc.) in the weight ratio of 65:35 followed by ball milling the mixture for 2 hours. The sintering profile comprised heating to 825° C. at 3° C./min followed by dwelling at 825° C. for 2 hours and then cooling down to 25° C. at 3° C./min. Each electrode was ˜40 μm thick with an effective cell area of 25 cm².

### Example 3: Testing of Solid Oxide Electrolysis (SOEC) Tube Cell

All cell tests and electrochemical measurements were carried out using in-house fabricated symmetric tube cells. The inlet gas feed (steam or mixture of steam/CO₂ or pure CO₂) was fed into the fuel chamber (inside the tube and contacting the fuel electrode (cathode)) at a constant flow rate of 30 to 50 ml/min. The oxygen electrode (anode) was exposed to the atmosphere with house air flow of 50 ml/min. A schematic of the set-up is shown in FIG. 11.

The mass flow meters were calibrated using separate certified flow meters. The temperature at the centre of the cathode was monitored using a single K-type thermocouple that will be designated henceforth as operating temperature. V-I curves (where reported) were taken using power supply (Keithley) and digital multi-meter (HP) to measure the voltage on electrode. Except for steam electrolysis, only single point measurements at 1.2 V or 1.5V were taken (no V-I curves due to experimental measurement limitations).

### Example 4: Synthesis of Syngas

An inlet gas feed of a mixture of steam and CO₂ was fed into the fuel chamber as described in Example 3. The amount of syngas (i.e. mixture of hydrogen and CO 1:1 vol %) produced using an SOEC tube cell comprising fuel electrodes made from the sintered hybrid electrode (i.e. sintered electrode material) is significantly higher than the prior art electrodes, as provided below:

| | |
|---|---|
| Operating | Amount of hydrogen |
| Voltage/ | and CO Mixture (1:1 vol %) |
| Equivalent | produced (Litres per hour |
| Energy | 25 cm² area cell) |

| per kg fuel | Prior art | Sintered hybrid |
|---|---|---|
| produced | electrode | electrode |
| 1.5 V/40.2 kWh | 2.5 | 3.5 |
| 1.2 V/32 kWh | 1.8 | 2.4 |

### Example 5: Steam Electrolysis

An inlet gas feed of steam was fed into the fuel chamber as described in Example 3. The amount of hydrogen produced using an SOEC tube cell comprising fuel electrodes made from the sintered hybrid electrode (i.e. sintered electrode material) is significantly higher than the prior art electrodes, as provided below:

| | |
|---|---|
| Operating | Amount of hydrogen |
| Voltage/ | produced from |
| Equivalent | steam (Litres per hour |
| Energy | 25 cm² area cell) |

| per kg H₂ | Prior art | Sintered hybrid |
|---|---|---|
| produced | electrode | electrode |
| 1.5 V/40.2 kWh | 2.9 | 3.5 |
| 1.2 V/32 kWh | 2.1 | 2.6 |

### Example 6: Synthesis of CO

An inlet gas feed of dry CO₂ was fed into the fuel chamber as described in Example 3. The amount of CO produced using an SOEC tube cell comprising fuel electrodes made from the sintered hybrid electrode (i.e. sintered electrode material) is significantly higher than the prior art electrodes, as provided below:

| | |
|---|---|
| Operating | Amount of CO produced |
| Voltage/ | from dry CO2 (Litres |
| Equivalent | per hour 25 cm2 |
| Energy | area cell) |

| per kg CO | Prior art | Sintered hybrid |
|---|---|---|
| produced | electrode | electrode |
| 1.5 V/40.2 kWh | 2.2 | 3.5 |
| 1.2 V/32 kWh | 1.7 | 2.6 |

### Example 7: Comparison to Electrodes Comprising Discrete Mixture of Ag and GDC

The performance of a symmetrical solid oxide electrolysis cells (SOECs) prepared using electrodes prepared using sintered hybrid particles (i.e. sintered electrode material) was compared to electrodes prepared using discrete silver and gadolinium doped ceria particles (CGO-Ag mixed). The symmetrical SOEC was prepared using the protocol outlined in Example 2.

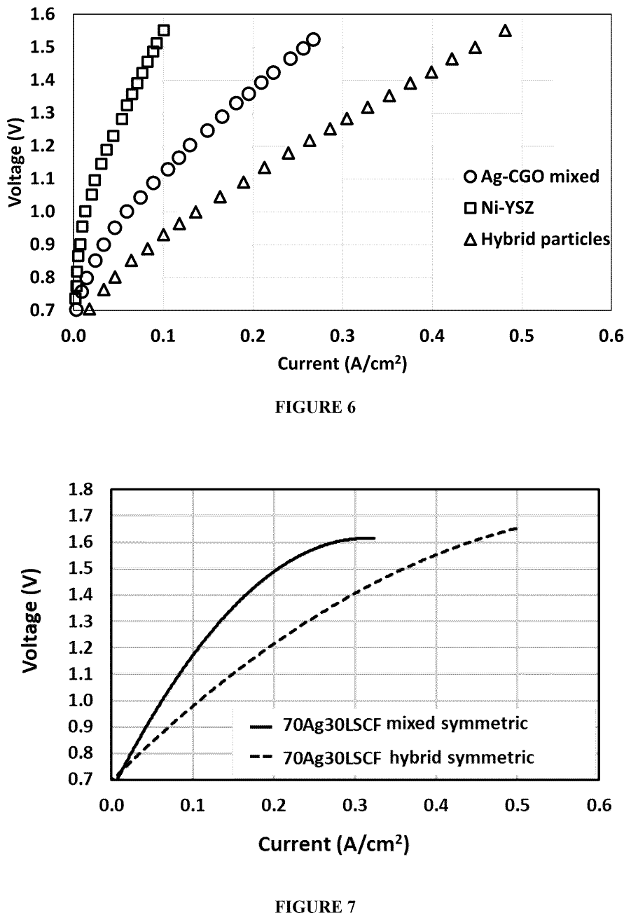

FIG. 6 shows the current-voltage (V-I) curves for a symmetric SOECs after loading at 1.5V for 2 hours, comprising electrodes prepared using a sintered material comprising a silver metal phase and one or more metal doped ceria particles or discrete portions interspersed within the silver metal phase; Ni—YSZ composite; or mixed CGO-AG, for steam electrolysis. The increase in current for the SOECs comprising electrodes fabricated using hybrid electrode particles can be attributed to the reduced electrode polarization resistance. Without wishing to be bound by theory, owing to the unique microstructure of the hybrid electrode particles, an ionic and electronic pathway is created to transfer electrons and mobile oxygen species (O²⁻) to and from the reactive sites located on the surface of each hybrid electrode particle resulting in higher performance compared to the blend of discrete silver and gadolinium doped ceria particles or conventional Ni—YSZ composites, leading to enhanced performance (e.g. reduced electrode polarization resistance).

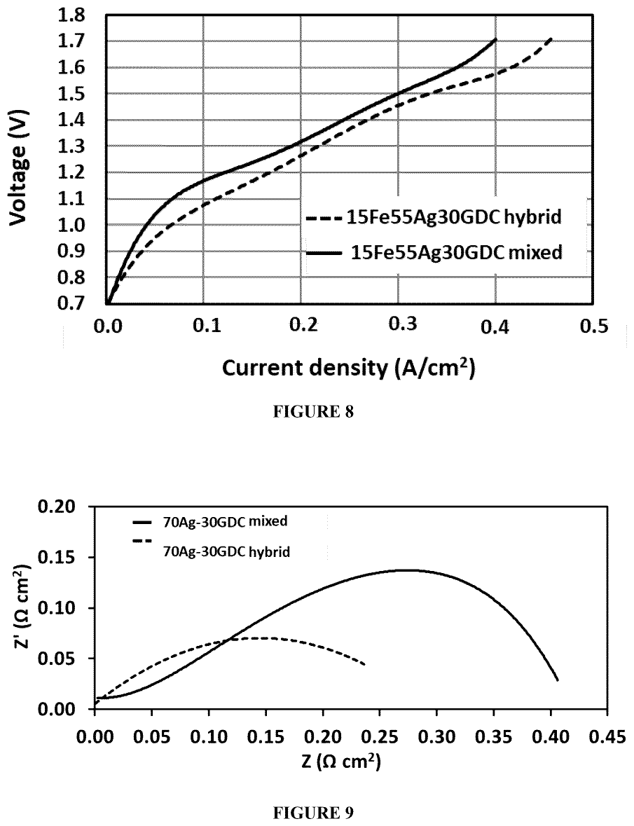

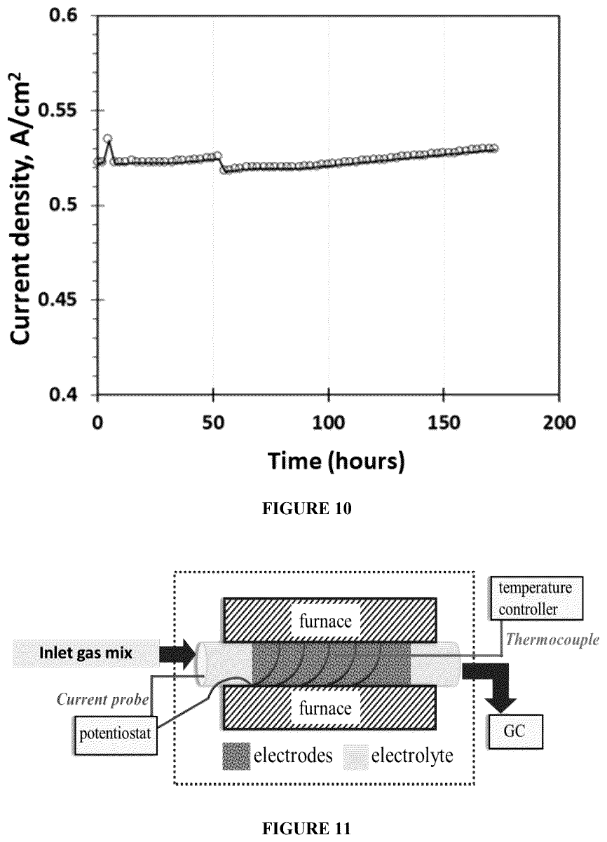

Similar improvement in the performance seen in other electrode configurations such as electrodes comprises of hybrid electrode particles of Ag and one or more doped ferrite phase and bimetallic phases with one or more metal doped ceria as shown in FIGS. 8 and 9. Electrode polarization resistance of these cells was measured to be <0.3 ohm cm² in comparison to to the blend of discrete metal and mixed ionic conducting phases (FIG. 10).

### Example 8: Stability of Electrode Compositions in Steam Electrolysis

The performance stability of a symmetrical solid oxide electrolysis cells (SOECs) prepared using electrodes comprising sintered hybrid particles was evaluated during steam electrolysis. FIG. 7 shows that after 150 hours steam electrolysis, the current density remained consistent between 0.5-0.55 A/cm⁻², highlighting the hybrid electrode compositions improved performance stability.

1. An electrode composition comprising a plurality of hybrid electrode particles, wherein each hybrid electrode particle comprises at least one metallic phase and one oxide phase, wherein the metallic phase comprises a plurality of metallic particles and the oxide phase comprises a plurality of ion or mixed ion conducting oxide particles on the surface of the metallic particle(s), wherein the plurality of ion or mixed ion conducting oxide particles are decorated on the surface of the metallic particle(s), wherein the particle size (in nm) of the ion or mixed ion conducting oxide particles on the surface of the metallic particle is between about 1 to 100.

2. The electrode composition of claim 1, wherein the metallic phase comprises at least one metallic particle selected from silver (Ag), iron (Fe), nickel (Ni) and cobalt (Co).

3. The electrode composition of claim 1 or claim 2, wherein the metallic phase comprises a combination of silver (Ag) particles and one or more of iron (Fe), nickel (Ni), cobalt (Co), Copper (Cu), and titanium (Ti).

4. The electrode composition of any one of claims 1 to 3, wherein the metallic phase comprises a combination of silver (Ag) particles and iron (Fe) particles.

5. The electrode composition of any one of claims 1 to 3, wherein the metallic phase comprises silver (Ag) particles.

6. The electrode composition of any one of claims 1 to 5, wherein the oxide phase comprises ion or mixed ion conducting oxide particles selected from metal (e.g. Gd, Sm, Pr, Ni) doped ceria, metal (e.g. Cu) doped ferrites, titanium doped lanthanum strontium ferrite (e.g. LSCF, LSTF), and lanthanum strontium chromium manganese (LSCM).

7. The electrode composition of any one of claims 1 to 6, wherein the size of the metallic particles is greater than the size of the ion or mixed ion conducting oxide particles.

8. The electrode composition of any one of claims 1 to 7, wherein the hybrid electrode particles have a particle size (in μm) of between about 0.05 to 5.

9. The electrode composition of any one of claims 1 to 8, wherein the metallic particle of each hybrid electrode particle has a particle size (in μm) of between about 0.1 to 5.

10. The electrode composition of any one of claims 1 to 9, wherein the composition is provided as a coating formulation comprising the hybrid electrode particles as a powder present in one or more solvents.

11. The electrode composition of claim 10, wherein the coating formulation is a dip coating formulation comprising the powder, one or more organic solvents, and optionally one or more binders.

12. The electrode composition of claim 10 or claim 11, wherein the coating formulation is a printable ink formulation comprising the powder, one or more organic solvents, and optionally one or more binders.

13. The electrode composition of any one of claims 1 to 12, wherein the electrode composition is provided as a sintered electrode material.

14. The electrode composition of claim 13, wherein the sintered electrode material comprises a metallic phase as a porous scaffold and plurality of discrete oxide phases interspersed within the metallic phase.

15. The electrode composition of claim 14, wherein the discrete oxide phase is in the form of ion or mixed ion conducting oxide particles.

16. The electrode composition of any one of claims 13 to 15, wherein the sintered electrode material comprises between about 10 to 100 discrete oxide phases per cm³ of metallic phase.

17. The electrode composition of any one of claims 13 to 16, wherein the sintered electrode material has a porosity (in vol %) based on the total volume of sintered electrode material of between about 10 to 60.

18. The electrode composition of any one of claims 13 to 17, wherein the thickness of the sintered electrode material (in μm) is between 1 and 100.

19. A modified sol-gel process for preparing hybrid electrode particles, wherein each hybrid electrode particle comprises at least one metallic phase and one oxide phase, wherein the metallic phase comprises plurality of metallic particles and the oxide phase comprises a plurality of ion or mixed ion conducting oxide particles on the surface of the metallic particle(s), wherein the plurality of ion or mixed ion conducting oxide particles are decorated on the surface of the metallic particle(s), wherein the particle size (in nm) of the ion or mixed ion conducting oxide particles on the surface of the metallic particle is between about 1 to 100, wherein the process comprises:
a) preparing a gel from an aqueous solution comprising a metallic species, an ion or mixed ion conducting oxide species, a plasticizer, and a chelating agent; and
b) heating the gel to obtain a powder composition comprising the hybrid electrode particles.

20. The modified sol-gel process of claim 19, wherein step a) comprises preparing an aqueous solution comprising the ion or mixed ion conducting oxide species, followed by addition of the chelating agent, plasticizer, and then metallic species to the aqueous solution.

21. The modified sol-gel process of claim 20, wherein the aqueous solution comprising the ion or mixed ion conducting oxide species, chelating agent and plasticizer is aged prior to the addition of the metallic species.

22. The modified sol-gel process of any one of claims 19 to 21, wherein after step a) but prior to step b) the process comprises aging the gel for a period of time and suitable temperature prior to the heating at step b) to any residual aqueous solution.

23. The modified sol-gel process of claim 22, wherein the aqueous solution and/or gel is aged for a period of time of between about 12 hours to 36 hours and at a temperature of between about 60° C. to 90° C.

24. The modified sol-gel process of any one of claims 19 to 23, wherein one or more of the ion or mixed ion conducting oxide species and metallic species, is provided as salts or hydrates thereof independently selected from hydroxides, chlorides, nitrates, and oxide salts.

25. The modified sol-gel process of any one of claims 19 to 24, wherein one or more of the ion or mixed ion conducting species and metallic species, is provided as nitrate salts or hydrates thereof.

26. The modified sol-gel process of any one of claims 19 to 25, wherein the metallic species comprises at least one metallic particle selected from silver (Ag), iron (Fe), nickel (Ni), and cobalt (Co).

27. The modified sol-gel process of any one of claims 19 to 26, wherein the metallic phase comprises a combination of silver (Ag) particles and one or more of iron (Fe), nickel (Ni), cobalt (Co), Copper (Cu), and titanium (Ti).

28. The modified sol-gel process of any one of claims 19 to 27, wherein the oxide phase consists of ion or mixed ion conducting oxide particles selected from metal (e.g. Gd, Sm, Pr, Ni) doped ceria, metal (e.g. Cu) doped ferrites, titanium doped lanthanum strontium ferrite (e.g. LSCF, LSTF), and lanthanum strontium chromium manganese (LSCM).

29. The modified sol-gel process of any one of claims 19 to 28, wherein the molar ratio of metallic species to ion or mixed ion conducting oxide species is about 1:5 to 5:1.

30. The modified sol-gel process of any one of claims 19 to 29, wherein the plasticizer is a glycol, preferably selected from ethylene glycol, diethylene glycol, and triethylene glycol.

31. The modified sol-gel process of any one of claims 19 to 30, wherein the chelating agent is selected from carboxylic acids (e.g. citric acid), amines, amino acids, aminopolycarboxylic acids (e.g. EDTA), diesters, β-diketones, β-ketoesters, and any combinations thereof.

32. The modified sol-gel process of any one of claims 19 to 31, wherein the gel is heated in step b) at a temperature of between about 300° C. to 600° C.

33. The modified sol-gel process of any one of claims 19 to 32, wherein step b) comprises flame spray pyrolysis or spray drying of the gel obtained from step a) to obtain the powder composition of hybrid electrode particles.

34. The modified sol-gel process of any one of claims 19 to 33, wherein the powder composition comprising the hybrid electrode particles is further processed into a dry powder formulation or wet coating formulation comprising one or more solvents.

35. The modified sol-gel process of claim 34, wherein the coating formulation is a dip coating formulation comprising one or more solvents.

36. The modified sol-gel process of claim 35, wherein the coating formulation is a printable ink formulation comprising the powder, one or more organic solvents, and one or more stabilisers.

37. The modified sol-gel process of any one of claims 19 to 36, wherein the powder composition or formulation thereof is sintered into a sintered electrode material.

38. The modified sol-gel process of claim 37, wherein the sintering is at a temperature of between about 500° C. to 900° C.

39. The modified sol-gel process of claim 37 or claim 38, wherein the sintered electrode material comprises a metallic phase as a porous scaffold and plurality of discrete ion or mixed ion conducting oxide phases interspersed within the metallic phase.

40. The modified sol-gel process of any one of claims 19 to 39, wherein an electrode is fabricated using the powder composition or a sintered electrode material thereof.

41. The modified sol-gel process of any one of claims 19 to 40, wherein a solid oxide electrochemical cell is prepared comprising an electrode comprising the powder composition or a sintered electrode material thereof.

42. The modified sol-gel process of claim 41, wherein the solid oxide electrochemical cell comprises a positive electrode and a negative electrode each comprising the powder composition or a sintered electrode material thereof.

43. An electrode comprising the electrode composition of any one of claims 1 to 18 or a sintered electrode material thereof.

44. A solid oxide electrochemical cell comprising a cathode, a solid oxide electrolyte, and an anode, wherein the cathode and/or the anode comprise the electrode composition of any one of claims 1 to 18 or a sintered electrode material thereof.

45. The electrode or solid oxide electrochemical cell of claim 43 or claim 44, wherein the sintered electrode material of the electrode composition comprises a metallic phase as a porous scaffold and plurality of discrete ion or mixed ion conducting oxide phases interspersed within the silver metal phase.

45. The electrode or solid oxide electrochemical cell of any one of claims 43 to 45, wherein the electrode composition or sintered electrode material thereof is coated on an electrode support.

46. The electrode or solid oxide electrochemical cell of any one of claims 43 to 45, wherein the sintered electrode material has a porosity (in vol %) based on the total volume of sintered electrode material of between about 10 to 60.

47. The electrode or solid oxide electrochemical cell of any one of claims 43 to 46, wherein the sintered electrode material comprises between about 50 to 500 discrete ion or mixed ion conducting oxide phases per cm³ of metallic phase.

48. The solid oxide electrochemical cell of any one of claims 44 to 47, wherein the solid oxide electrolyte is selected from yttria stabilized zirconia (YSZ), scandia stabilized zirconia (SSZ), gadolinia doped ceria (GDC), samaria doped ceria (SDC), samaria-neodymium doped ceria (SNDC), erbia stabilized bismuth oxide (ESB), yttria stabilized bismuth oxide (YSB), strontium or magnesium doped lanthanum gallate (LSGM), and combinations thereof.

49. The solid oxide electrochemical cell of any one of claims 44 to 48, wherein the solid oxide electrochemical cell is a solid oxide electrolysis cell (SOEC), a solid oxide fuel cell (SOFC), or a reversible solid oxide electrochemical cell.

50. The solid oxide electrochemical cell of claim 49, wherein the solid oxide electrochemical cell is a solid oxide electrolysis cell (SOEC) configured for the synthesis of one or more of oxygen, hydrogen, carbon monoxide, or syngas.

51. The solid oxide electrochemical cell of claim 49, wherein the solid oxide electrochemical cell is a solid oxide fuel cell (SOFC) for conversion of chemical energy from one of more of a hydrogen, ammonia, hydrocarbon, alcohol, syngas, solid carbon, and biomass SOFC into electric and/or thermal energy.

52. The solid oxide electrochemical cell of any one of claims 44 to 51, wherein the solid oxide electrochemical cell is a symmetrical solid oxide electrochemical cell having a positive electrode and a negative electrode, each electrode comprising the electrode composition or a sintered electrode material thereof.

53. Use of the electrode composition of any one of claims 1 to 18 or a sintered electrode material thereof in preparing an electrode or electrode material for a solid oxide electrochemical cell.

54. The use of claim 53, wherein the solid oxide electrochemical cell is a solid oxide electrolysis cell (SOEC), a solid oxide fuel cell (SOFC), or a reversible solid oxide electrochemical cell.

55. The use of claim 54, wherein the solid oxide electrochemical cell is a solid oxide electrolysis cell (SOEC) configured for the synthesis of one or more of oxygen, hydrogen, carbon monoxide, or syngas.

56. The use of claim 54, wherein the solid oxide electrochemical cell is a solid oxide fuel cell (SOFC) selected from a hydrogen, ammonia, hydrocarbon, alcohol, syngas, solid carbon, and biomass SOFC.

57. The use of any one of claims 53 to 56, wherein the solid oxide electrochemical cell is a symmetrical solid oxide electrochemical cell having a positive electrode and a negative electrode, each electrode comprising the electrode composition or a sintered electrode material thereof.

58. A method of manufacturing a solid oxide electrochemical cell comprising:
a) preparing one or more solid oxide electrolyte layers;
b) applying an electrode composition to one or both sides of the solid oxide electrolyte layer(s) to form a solid oxide electrochemical cell component, wherein the electrode composition applied to at least one side the solid oxide electrolyte layer(s) comprises an electrode composition of any one of claims 1 to 18; and
c) sintering the electrode composition applied onto the solid oxide electrochemical cell component to form an electrode or electrode material.

59. The method of claim 58, wherein step b) comprises applying an electrode composition of any one of claims 1 to 18 to both sides of the solid oxide electrolyte layer.

60. The method of claim 58 or claim 59, wherein the solid oxide electrochemical cell is a symmetrical cell comprising a positive and a negative electrode on opposing sides of the solid oxide electrolyte layer(s) each electrode comprising or consisting of the electrode composition of any one of claims 1 to 18
